(19) United States
(12) Patent Application Publication
(10) Pub. No.: US 2025/0155832 A1
(43) Pub. Date: May 15, 2025

(54) GREEN TONER FOR ELECTROSTATIC CHARGE IMAGE DEVELOPMENT, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Kotaro Yoshihara, Kanagawa (JP); Asafumi Fujita, Kanagawa (JP); Tomoaki Tanaka, Kanagawa (JP); Tsuyoshi Murakami, Kanagawa (JP)

(73) Assignee: FUJIFILM Business Innovation Corp., Tokyo (JP)

(21) Appl. No.: 18/646,106

(22) Filed: Apr. 25, 2024

(30) Foreign Application Priority Data
Nov. 14, 2023 (JP) 2023-193887

(51) Int. Cl. G03G 9/09; G03G 15/01

(52) U.S. Cl. CPC G03G 9/0926; G03G 9/0906; G03G 15/0126; G03G 15/0189; G03G 2215/066; G03G 2221/183

(57) ABSTRACT

A green toner for electrostatic charge image development, the green toner includes: green toner particles; and a lubricant externally added to the green toner particles, the green toner particles containing: a binder resin; an azomethine fluorescent pigment having an emission peak in a region of wavelengths of 500 nm or more and 550 nm or less of an emission spectrum; and a non-fluorescent pigment having a reflection peak in a region of wavelengths of 480 nm or more and 540 nm or less of a reflection spectrum, wherein a mass proportion of the azomethine fluorescent pigment in the green toner particles is 3% by mass or more and 10% by mass or less, and a mass-based ratio M1/M2 of a content M1 of the azomethine fluorescent pigment to a content M2 of the non-fluorescent pigment is 1 or more and 5 or less.

### CROSS-REFERENCE TO RELATED APPLICATIONS

This application is based on and claims priority under 35 USC 119 from Japanese Patent Application No. 2023-193887 filed Nov. 14, 2023.

### BACKGROUND

### (i) Technical Field

The present disclosure relates to a green toner for electrostatic charge image development, an electrostatic charge image developer, a toner cartridge, a process cartridge, an image forming apparatus, and an image forming method.

### (ii) Related Art

JP2012-189989 μA discloses a green toner for electrostatic charge image development, including C. I. Solvent Green 5 and a phthalocyanine-based colorant compound X, wherein the content of the C. I. Solvent Green 5 in the total amount of colorants is 5% by mass or more and 50% by mass or less.

JP2016-017135 μA discloses a colorant composition containing a copper phthalocyanine pigment, a fluorescent dye, and a resin binder, wherein a coated product of the composition on white paper has a hue angle of 236° or less, and a coating film formed of the fluorescent dye containing no copper phthalocyanine pigment and the resin binder has a maximum reflectance of 90 to 130% in the visible reflection spectrum.

JP2011-128414 μA discloses a toner for electrostatic charge image development including a yellow non-fluorescent dye whose peak wavelength of absorbance spectrum is in a wavelength range of 400 to 480 nm, and a fluorescent dye whose peak wavelength of emission spectrum is in a wavelength range of 480 to 560 nm, wherein a content of the non-fluorescent dye is 2 to 8 parts by mass with respect to 100 parts by mass of a binder resin, a content of the fluorescent dye is 0.05 to 0.2 parts by mass with respect to 100 parts by mass of the binder resin, and a content ratio represented by an expression (content of non-fluorescent dye/content of fluorescent dye) is in a range of 15 to 150.

JP2017-003818 μA discloses a toner satisfying W_{G}×0.5>W_{F}>W_{G}×0.025, P_{G}<P_{F}, where W_{G} and W_{F} respectively represent mass-based contents of a coloring pigment and a fluorescent dye, P_{G} represents an absorption peak wavelength of the coloring pigment, and P_{F} represents an emission peak wavelength of the fluorescent dye.

JP2004-037734 μA discloses a developer including a toner including fine particles having a volume-average particle size of 80 to 300 nm, an abrasive, and a lubricant that are externally added, wherein a relationship of A<B<C is satisfied where the volume-average particle sizes of the fine particles, the abrasive, and the toner are A, B, and C, respectively.

JP2014-115341 μA discloses a toner for electrostatic charge image development containing a binder resin, a wax, and a colorant, wherein silica particles, abrasive particles, and wax particles are externally added to the surface of the toner.

### SUMMARY

An image display part of an electronic device is typically in a so-called RGB color mode in which colors are expressed by a combination of three colors of red (R), green (G), and blue (B).

On the other hand, image formation in an electrophotographic type is typically in a so-called CMYK color mode in which colors are expressed by a combination of four colors of cyan (C), magenta (M), yellow (Y), and black (K).

When an image expressed in the RGB color mode is reproduced on a recording medium in the CMYK color mode, secondary colors such as green, pink, and orange tend to become dull.

A green toner, a pink toner, or an orange toner has been developed for the purpose of enhancing color reproducibility of green, pink, or orange in image formation in the electrophotographic type. As the green toner, a toner containing a yellow fluorescent dye (for example, C. I. Solvent Green 5) and a green pigment or a blue pigment is known.

However, since a fluorescent dye typically undergoes concentration quenching in which emission attenuates as the concentration increases, it is difficult to achieve color reproduction with higher lightness and higher chroma with a green toner containing a fluorescent dye.

For the purpose of achieving color reproduction with high lightness and high chroma, development of a green toner in which a fluorescent dye is replaced with a fluorescent pigment has been advanced.

From the viewpoint of enhancing the lightness and chroma of a green image, the dispersed particle size of the fluorescent pigment in the green toner particles is preferably large, but when the dispersed particle size of the fluorescent pigment is large, the filler effect is weakened, and the mechanical strength of the green toner particles is lowered. When the mechanical strength of the toner particles is lowered, the toner particles are broken and generate a small-size toner. The small-size toner is not easily transferred, and filming may occur on the surface of an image holding member. In addition, the small-size toner is not easily transferred, is accumulated on a cleaning blade of the image holding member, and is taken into an external additive dam, which may make the external additive dam brittle and break the external additive dam. In addition, the pigment exposed to the small-size toner may excessively abrade the surface of the image holding member. Either case leads to generation of color streaks in an image.

Aspects of non-limiting embodiments of the present disclosure relate to a green toner for electrostatic charge image development with which color streaks hardly occur as compared with a green toner for electrostatic charge image development to which no lubricant is externally added.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a green toner for electrostatic charge image development, the green toner comprising:
green toner particles; and
a lubricant externally added to the green toner particles,
the green toner particles containing:
a binder resin;
an azomethine fluorescent pigment having an emission peak in a region of wavelengths of 500 nm or more and 550 nm or less of an emission spectrum; and
a non-fluorescent pigment having a reflection peak in a region of wavelengths of 480 nm or more and 540 nm or less of a reflection spectrum,
wherein
a mass proportion of the azomethine fluorescent pigment in the green toner particles is 3% by mass or more and 10% by mass or less, and
a mass-based ratio M1/M2 of a content M1 of the azomethine fluorescent pigment to a content M2 of the non-fluorescent pigment is 1 or more and 5 or less.

### BRIEF DESCRIPTION OF THE DRAWINGS

Exemplary embodiments of the present invention will be described in detail based on the following figures, wherein:

FIG. 1 is a schematic configuration diagram illustrating an example of an image forming apparatus according to a present exemplary embodiment; and

FIG. 2 is a schematic configuration diagram illustrating an example of a process cartridge detachably attached to the image forming apparatus according to the present exemplary embodiment.

### DETAILED DESCRIPTION

Hereinafter, exemplary embodiments of the present disclosure will be described. These descriptions and examples are illustrative of the exemplary embodiments and are not intended to limit the scope of the exemplary embodiments.

In the present disclosure, “A and/or B” is synonymous with “at least one of A or B”. That is, “A and/or B” means it may be only A, only B, or a combination of A and B.

The numerical ranges expressed by using “to” in the present disclosure denote ranges including the numerical values before and after “to” as the minimum value and the maximum value.

The upper limit or the lower limit of one numerical range in stepwise numerical ranges in the present disclosure may be replaced with the upper limit or the lower limit of another stepwise numerical range. The upper limit or the lower limit of any numerical range described in the present disclosure may be replaced with a value described in examples.

In the present disclosure, the term “step” includes not only an independent step but also a step that cannot be clearly distinguished from other steps but achieves the purpose of the step.

When an exemplary embodiment is described with reference to the drawings in the present disclosure, the structure of the exemplary embodiment is not limited to the structure illustrated in the drawings. The sizes of the members in each drawing are conceptual sizes, and the relative relationship between the sizes of the members is not limited to that shown in the drawings.

In the present disclosure, each component may contain a plurality of corresponding substances. In the present disclosure, the amount of each component in a composition refers to, when there are a plurality of substances corresponding to each component in the composition, the total amount of the plurality of substances present in the composition unless otherwise specified.

In the present disclosure, the particles corresponding to each component may include a plurality of types. When a plurality of types of particles corresponding to each component are present in a composition, the particle size of each component means a value for a mixture of the plurality of types of particles present in the composition unless otherwise specified.

In the present disclosure, when a compound is represented by a structural formula, it may be represented by a structural formula in which symbols (C and H) representing a carbon atom and a hydrogen atom in a hydrocarbon group and/or a hydrocarbon chain are omitted.

In the present disclosure, the term “(meth)acryl” is an expression that includes both acryl and methacryl, and the term “(meth)acrylate” is an expression that includes both acrylate and methacrylate.

In the present disclosure, the term “toner for electrostatic charge image development” is also referred to as “toner”, the term “green toner for electrostatic charge image development” is also referred to as “green toner”, the term “electrostatic charge image developer” is also referred to as “developer”, and the term “carrier for electrostatic charge image development” is also referred to as “carrier”.

In the present disclosure, the Colour Index is abbreviated as “C. I.”

### <Green Toner for Electrostatic Charge Image Development>

In the present disclosure, the green toner means a toner with which a hue angle h of a solid image (image having a density of 100%) formed on coated paper is 128.5° or more and 144.5° or less. The hue angle h is an angle calculated by the following expression from a* value and b* value of the CIE1976 L*a*b* color system.

Hue angle h=tan⁻¹(b*/a*)

In the present disclosure, the hue angle h of a solid image formed with the green toner on coated paper is preferably 1310 or more and 1430 or less, more preferably 1350 or more and 1400 or less.

A solid image (image having a density of 100%) formed with the green toner on coated paper in the present disclosure preferably has a lightness L* of 70 or more and a chroma C* of 85 or more in the CIE1976 L*a*b* color system. The chroma C* is a value calculated by the following expression from a* value and b* value in the CIE1976 L*a*b* color system.

Chroma C*={(a*)²+(b*)²}^{0.5}

In the present disclosure, the fluorescent pigment refers to a pigment that emits light with light energy from the outside, and the non-fluorescent pigment refers to a pigment that does not emit light with light energy from the outside. Usually, a fluorescent pigment is colored by reflected light and emitted light, and a non-fluorescent pigment is colored only by reflected light.

The green toner according to the present exemplary embodiment includes green toner particles. The green toner particles contain a binder resin, an azomethine fluorescent pigment having an emission peak in a region of wavelengths of 500 nm or more and 550 nm or less of an emission spectrum, and a non-fluorescent pigment having a reflection peak in a region of wavelengths of 480 nm or more and 540 nm or less of a reflection spectrum.

That is, the green toner particles in the exemplary embodiment are toner particles containing a yellow fluorescent pigment and a green pigment or a blue pigment.

Hereinafter, the “azomethine fluorescent pigment having an emission peak in a region of wavelengths of 500 nm or more and 550 nm or less of an emission spectrum” is referred to as “azomethine fluorescent pigment (Y)”, and the “non-fluorescent pigment having a reflection peak in a region of wavelengths of 480 nm or more and 540 nm or less of a reflection spectrum” is referred to as “pigment (G)”.

In the green toner particles in the exemplary embodiment, the mass proportion of the azomethine fluorescent pigment (Y) in the green toner particles is 3% by mass or more and 10% by mass, and the mass-based ratio M1/M2 of the content M1 of the azomethine fluorescent pigment (Y) to the content M2 of the pigment (G) is 1 or more and 5 or less.

From the viewpoint that the image develops a desired green color, the mass proportion of the azomethine fluorescent pigment (Y) is 3% by mass or more and 10% by mass or less, preferably 4% by mass or more and 9% by mass or less, more preferably 5% by mass or more and 8% by mass or less.

When the ratio M1/M2 is less than 1, the tint of the image is shifted to bluish tint. When the ratio M1/M2 is more than 5, the tint of the image is shifted to yellowish tint. From the viewpoint that the image develops a desired green color, the ratio M1/M2 is 1 or more and 5 or less, preferably 1.5 or more 4.5 or less, and more preferably 2 or more and 4 or less.

The green toner particles in the present exemplary embodiment preferably have a total content of the azomethine fluorescent pigment (Y) and the pigment (G) of 5% by mass or more and 15% by mass or less with respect to the entire green toner particles.

When the total content of the pigments is 5% by mass or more, the chroma of a green image is high. From the viewpoint of increasing the chroma of a green image, the total content of the pigments is preferably 5% by mass or more, more preferably 7% by mass or more, and still more preferably 9% by mass or more.

When the total content of the pigments is 15% by mass or less, the lightness of a green image is high. From the viewpoint of increasing the lightness of a green image, the total content of the pigments is preferably 15% by mass or less, more preferably 14% by mass or less, and still more preferably 12% by mass or less.

The difference in wavelengths between the emission peak of the azomethine fluorescent pigment (Y) having the maximum content among the azomethine fluorescent pigments (Y) contained in the green toner particles in the exemplary embodiment and the reflection peak of the pigment (G) having the maximum content among the pigments (G) contained in the green toner particles is preferably 40 nm or less from the viewpoint of increasing the lightness and chroma of the green image. The difference between the wavelengths of the emission peak and the reflection peak is preferably as small as possible, more preferably 30 nm or less, still more preferably 20 nm or less, still more preferably 10 nm or less, still more preferably 5 nm or less, and ideally 0 nm.

In all the combinations of the emission peaks of the azomethine fluorescent pigments (Y) and the reflection peaks of the pigments (G) contained in the green toner particles in the present exemplary embodiment, the difference in wavelengths between the emission peak and the reflection peak is preferably 40 nm or less, from the viewpoint of increasing the lightness and chroma of the green image. The difference between the wavelengths of the emission peak and the reflection peak is preferably as small as possible, more preferably 30 nm or less, still more preferably 20 nm or less, still more preferably 10 nm or less, still more preferably 5 nm or less, and ideally 0 nm.

The green toner according to the present exemplary embodiment preferably has a color difference ΔE of 13.5 or less from a color sample TOKA FLASH VIVA DX 650 (T&K TOKA Co., Ltd.) in the CIE1976 L*a*b* color system when a solid image (image having a density of 100%) is formed on coated paper. The color difference ΔE is preferably as small as possible, more preferably 10 or less, still more preferably 6.5 or less, still more preferably 3 or less, still more preferably 1 or less, and ideally 0.

In the present exemplary embodiment, the color difference ΔE of the green toner from the color sample TOKA FLASH VIVA DX 650 (T&K TOKA Co., Ltd.) in the CIE1976 L*a* b* color system is defined by the following expression.

$$Δ E = \sqrt{{( {L}_{1} - {L}_{2} )}^{2} + {( {a}_{1} - {a}_{2} )}^{2} + {( {b}_{1} - {b}_{2} )}^{2}} \qquad [ Expression 1 ]$$

In the above formula, L₁, a₁, b₁, and L₂, a₂, b₂ are L* values, a* values, and b* values in the CIE1976 L*a*b* color system. L₁, a₁, b₁ are L* value, a* value, and b* value of the color sample TOKA FLASH VIVA DX 650, and are values obtained by measuring the color sample TOKA FLASH VIVA DX 650 with a reflection spectrodensitometer. L₂, a₂, b₂ are L* value, a* value, and b* value of an image formed by the green toner, and are values obtained by measuring the image with a reflection spectrodensitometer. The color sample TOKA FLASH VIVA DX 650 (T&K TOKA Co., Ltd.) is a color sample in which an image is formed on coated paper, and the image formed with the green toner is also formed on coated paper and then the color difference ΔE is measured.

In the present exemplary embodiment, the coordinate values of the green toner in the CIE1976 L*a*b* color system are measured by the following method.

A green toner as a sample is mixed with a carrier and then put into a developing device of an image forming apparatus, and a solid image (image having a density of 100%) having a toner applied amount of 4.0 g/m² is formed on coated paper at a fixing temperature of 180° C. The coordinate values of the formed solid image in the CIE1976 L *a*b* color system are measured at 10 random locations using a reflection spectrodensitometer, and the mean values of the L* values, the a* values, and the b* values are calculated.

For the green toner according to the exemplary embodiment, the reflectance of the reflection peak in a spectral reflection spectrum of a solid image formed on coated paper is preferably 70% or more.

The green toner according to the exemplary embodiment includes a lubricant externally added to the green toner particles. The lubricant is preferably in the form of particles (that is, lubricant particles).

For the green toner, the dispersed particle size of the fluorescent pigment in the green toner particles is preferably relatively large from the viewpoint of increasing the lightness and chroma of the green image, but the mechanical strength of the green toner particles is thereby relatively low, and a small-size toner tends to be generated. The small-size toner is not easily transferred, and filming may occur on the surface of an image holding member. In addition, the pigment exposed to the small-size toner may excessively abrade the surface of an image holding member. Either case leads to generation of color streaks in an image.

In contrast, the green toner according to the present exemplary embodiment includes a lubricant as an external additive, and thus hardly causes filming of the surface of the image holding member and excessive abrasion of the image holding member, thereby preventing generation of color streaks in an image.

Hereinafter, the configuration of the green toner according to the present exemplary embodiment will be described in detail.

### [Green Toner Particles]

The green toner particles contain a binder resin, an azomethine fluorescent pigment (Y), and a pigment (G), and as necessary, contain a release agent and other additives.

—Azomethine fluorescent pigment (Y)—

The azomethine fluorescent pigment (Y) has an emission peak in a region of wavelengths of 500 nm or more and 550 nm or less of an emission spectrum. The emission peak of the azomethine fluorescent pigment (Y) is preferably in a region of wavelengths of 505 nm or more and 540 nm or less, more preferably in a region of wavelengths of 510 nm or more and 535 nm or less, and still more preferably in a region of wavelengths of 515 nm or more and 530 nm or less.

The azomethine fluorescent pigment (Y) is a pigment having an azomethine structure (that is, —R¹C═N—, R¹ is a hydrogen atom or a monovalent substituent) in the molecule. The azomethine fluorescent pigment (Y) is preferably bisazomethine, that is, a compound having —R¹C═N—N═CR²— (R¹ and R² each independently is a hydrogen atom or a monovalent substituent) in the molecule.

Examples of the azomethine fluorescent pigment (Y) include the following azomethine compounds (1) to (3).

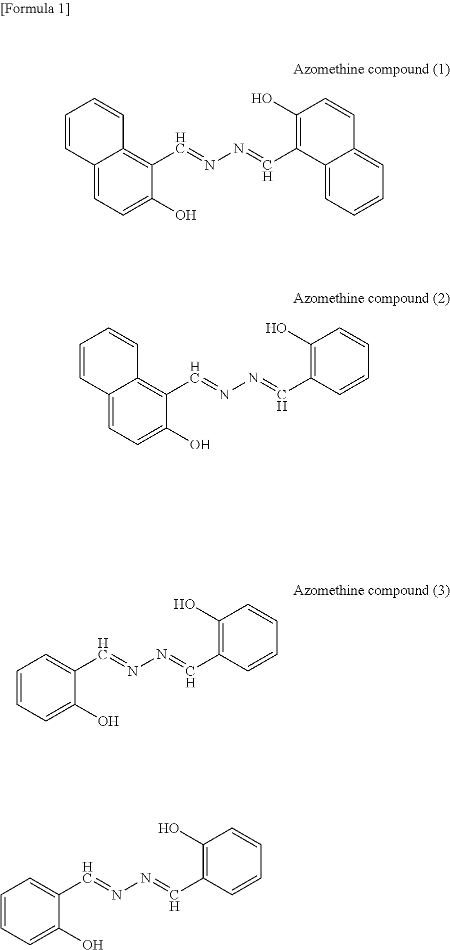 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O ; Oc1ccccc1/C=N/N=C/c1ccccc1O]

The emission peak of the azomethine compound (1) is 520 nm.

The emission peak of the azomethine compound (2) is 510 nm.

The emission peak of the azomethine compound (3) is 520 nm.

The azomethine fluorescent pigment (Y) is preferably at least one selected from the group consisting of the azomethine compound (1), the azomethine compound (2), and the azomethine compound (3).

The azomethine fluorescent pigment (Y) is preferably C. I. Pigment Yellow 101. C. I. Pigment Yellow 101 is the azomethine compound (1).

The volume-average particle size D1 of the azomethine fluorescent pigment (Y) is preferably 30 nm or more and 800 nm or less, more preferably 50 nm or more and 700 nm or less, still more preferably 150 nm or more and 600 nm or less, and still more preferably 250 nm or more and 400 nm or less, from the viewpoint of achieving dispersibility in toner particles, colorability on recording media, fixability to recording media, and the like in a well-balanced manner.

The volume-average particle size of a pigment is measured with a laser diffraction particle size distribution analyzer (for example, LA-700 manufactured by HORIBA, Ltd.) with the pigment dispersed in an aqueous solution of a surfactant. The volume-based particle size distribution is drawn from the small particle size side, and the particle size at 50% accumulation is taken as the volume-average particle size.

In the green toner according to the exemplary embodiment, from the viewpoint of increasing the reflectance of the reflection peak in the spectral reflection spectrum, it is preferable that the volume-average particle size D1 of the azomethine fluorescent pigment (Y) is 30 nm or more and 800 nm or less, and the volume-average particle size D1 of the azomethine fluorescent pigment (Y) and the volume-average particle size D2 of the pigment (G) satisfy the relationship D1>D2.

In the description above, D1 is more preferably 50 nm or more and 700 nm or less, still more preferably 150 nm or more and 600 nm or less, and still more preferably 250 nm or more and 400 nm or less.

### —Pigment (G)—

The pigment (G) has a reflection peak in a region of wavelengths of 480 nm or more and 540 nm or less of a reflection spectrum. The reflection peak of the pigment (G) is preferably in a region of wavelengths of 485 nm or more and 535 nm or less, more preferably in a region of wavelengths of 490 nm or more and 530 nm or less, and still more preferably in a region of wavelengths of 495 nm or more and 525 nm or less.

Examples of the pigment (G) include a halogenated phthalocyanine compound and a lake pigment of triphenylmethane dyes. As the pigment (G), a halogenated phthalocyanine compound is preferable.

As the pigment (G), a halogenated phthalocyanine compound is preferable, and at least one selected from the group consisting of halogenated copper phthalocyanine and halogenated zinc phthalocyanine is preferable.

Examples of the halogenated copper phthalocyanine include C. I. Pigment Green 7 (reflection peak 500 nm), C. I. Pigment Green 36 (reflection peak 510 nm), and C. I. Pigment Blue 76 (reflection peak 490 nm).

Examples of the halogenated zinc phthalocyanine include C. I. Pigment Green 58 (reflection peak 515 nm) and C. I. Pigment Green 59 (reflection peak 520 nm).

The pigment (G) is preferably at least one selected from the group consisting of C. I. Pigment Green 7, C. I. Pigment Green 36, C. I. Pigment Green 58, C. I. Pigment Green 59, and C. I. Pigment Blue 76.

The volume-average particle size D2 of the pigment (G) is preferably 20 nm or more and 400 nm or less, more preferably 50 nm or more and 300 nm or less, still more preferably 100 nm or more and 250 nm or less, and still more preferably 120 nm or more and 200 nm or less, from the viewpoint of achieving dispersibility in the toner particles, colorability on recording media, fixability to recording media, and the like in a well-balanced manner.

The volume-average particle size of a pigment is measured with a laser diffraction particle size distribution analyzer (for example, LA-700 manufactured by HORIBA, Ltd.) with the pigment dispersed in an aqueous solution of a surfactant. The volume-based particle size distribution is drawn from the small particle size side, and the particle size at 50% accumulation is taken as the volume-average particle size.

The volume-average particle size D1 of the azomethine fluorescent pigment (Y) and the volume-average particle size D2 of the pigment (G) preferably satisfy the relationship of D1>D2 from the viewpoint of increasing the reflectivity of the reflection peak in a spectral reflection spectrum.

The ratio D1/D2 of the volume-average particle size D1 of the azomethine fluorescent pigment (Y) to the volume-average particle size D2 of the pigment (G) is preferably more than 1 and 3 or less, more preferably 1.2 or more and 2.5 or less, and still more preferably 1.5 or more and 2 or less, from the viewpoint of increasing the lightness and chroma of a green image.

The green toner particles may contain any other colorant other than the azomethine fluorescent pigment (Y) and the pigment (G).

The total amount of the azomethine fluorescent pigment (Y) and the pigment (G) in the entire colorants contained in the green toner particles is preferably 90% by mass or more, more preferably 95% by mass or more, and still more preferably 100% by mass.

### —Binder Resin—

Examples of the binder resin include a vinyl resin formed of homopolymers of monomers such as styrenes (e.g., styrene, parachlorostyrene, α-methylstyrene), (meth)acrylic acid esters (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate), ethylenically unsaturated nitriles (e.g., acrylonitrile, methacrylonitrile), vinyl ethers (e.g., vinyl methyl ether, vinyl isobutyl ether), vinyl ketones (e.g., vinyl methyl ketone, vinyl ethyl ketone, vinyl isopropenyl ketone), and olefins (e.g., ethylene, propylene, butadiene) and a vinyl resin formed of a copolymer obtained by combining two or more types of these monomers.

Examples of the binder resin also include non-vinyl resins such as an epoxy resin, a polyester resin, a polyurethane resin, a polyamide resin, a cellulose resin, a polyether resin, and a modified rosin, mixtures of any of these and the vinyl resin, and graft polymers obtained by polymerizing vinyl monomers in the presence of any of these.

These binder resins may be used alone or in combination of two or more thereof.

A polyester resin is suitable as the binder resin.

Examples of the polyester resin include known polyester resins.

Examples of the polyester resin include a condensation polymer of a polyvalent carboxylic acid and a polyhydric alcohol. As the polyester resin, a commercially available product may be used, or a synthesized product may be used.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenylsuccinic acid, adipic acid, sebacic acid), alicyclic dicarboxylic acids (e.g., cyclohexanedicarboxylic acid), aromatic dicarboxylic acids (e.g., terephthalic acid, isophthalic acid, phthalic acid, naphthalenedicarboxylic acid), anhydrides thereof, and lower (for example, having 1 to 5 carbon atoms) alkyl esters thereof. Of these, for example, an aromatic dicarboxylic acid is preferable as the polyvalent carboxylic acid.

As the polyvalent carboxylic acid, a carboxylic acid having a valence of three or more and having a crosslinked structure or a branched structure may be used in combination with a dicarboxylic acid. Examples of the carboxylic acid having a valence of three or more include trimellitic acid, pyromellitic acid, anhydrides thereof, and lower (for example, having 1 to 5 carbon atoms) alkyl esters thereof.

The polyvalent carboxylic acid may be used alone or in combination of two or more thereof.

Examples of the polyhydric alcohol include aliphatic diols (e.g., ethylene glycol, diethylene glycol, triethylene glycol, propylene glycol, butanediol, hexanediol, neopentyl glycol), alicyclic diols (e.g., cyclohexanediol, cyclohexanedimethanol, hydrogenated bisphenol A), and aromatic diols (e.g., ethylene oxide adducts of bisphenol A, propylene oxide adducts of bisphenol A). Of these, as the polyhydric alcohol, for example, an aromatic diol and an alicyclic diol are preferable, and an aromatic diol is more preferable.

As the polyhydric alcohol, a polyhydric alcohol having a valence of three or more and having a crosslinked structure or a branched structure may be used in combination with a diol.

Examples of the polyhydric alcohol having a valence of three or more include glycerin, trimethylolpropane, and pentaerythritol.

The polyhydric alcohol may be used alone or in combination of two or more thereof.

The glass transition temperature (Tg) of the polyester resin is preferably 50° C. or more and 80° C. or less, more preferably 50° C. or more and 65° C. or less.

The glass transition temperature is obtained from a DSC curve obtained by differential scanning calorimetry (DSC), and more specifically, it is obtained according to “Extrapolated Glass-Transition Starting Temperature” described in the method for obtaining a glass-transition temperature in JIS K 7121-1987 “Testing Methods for Transition Temperatures of Plastics”.

The weight-average molecular weight (Mw) of the polyester resin is preferably 5,000 or more and 1,000,000 or less and more preferably 7,000 or more and 500,000 or less.

The number-average molecular weight (Mn) of the polyester resin is preferably 2,000 or more and 100,000 or less.

The molecular weight distribution Mw/Mn of the polyester resin is preferably 1.5 or more and 100 or less, more preferably 2 or more and 60 or less.

The weight-average molecular weight and the number-average molecular weight are measured by gel permeation chromatography (GPC). The molecular weight measurement by GPC is performed with a THF solution, using GPC HLC-8120GPC manufactured by Tosoh Corporation as a measurement apparatus and a column TSKgel SuperHM-M (15 cm) manufactured by Tosoh Corporation. The weight-average molecular weight and the number-average molecular weight are calculated from the measurement results using a molecular weight calibration curve created with monodisperse polystyrene standard samples.

The polyester resin is obtained by a known production method. Specifically, for example, the polyester resin is obtained by a method in which the polymerization temperature is set to 180° C. or more and 230° C. or less, the pressure in the reaction system is reduced as necessary, and the reaction is performed while water or alcohol generated at the time of condensation is removed.

When the raw material monomers are not dissolved or compatibilized at the reaction temperature, a solvent having a high boiling point may be added as a solubilizing agent to dissolve the monomers. In this case, the polycondensation reaction is performed while distilling off the solubilizing agent. When a monomer having poor compatibility is present, the monomer having poor compatibility and an acid or alcohol to be polycondensed with the monomer may be condensed in advance, and then the resultant may be polycondensed with the main component.

The content of the binder resin is preferably 40% by mass or more and 95% by mass or less, more preferably 50% by mass or more and 90% by mass or less, and still more preferably 60% by mass or more and 85% by mass or less with respect to the entire toner particles.

### —Release Agent—

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited to these agents.

The melting temperature of the release agent is preferably 50° C. or more and 110° C. or less, and more preferably 60° C. or more and 100° C. or less.

The melting temperature is determined from a DSC curve obtained by differential scanning calorimetry (DSC) according to “Melting Peak Temperature” described in a method for determining a melting temperature in JIS K 7121-1987 “Testing Methods for Transition Temperatures of Plastics”.

The content of the release agent is preferably 1% by mass or more and 20% by mass or less, more preferably 4% by mass or more and 15% by mass or less with respect to the entire toner particles.

### —Other Additives—

Examples of the other additives include known additives such as a magnetic material, a charge control agent, and an inorganic powder. These additives are included in the toner particles as internal additives.

### —Properties of Toner Particles and the Like—

The toner particles may be toner particles having a single-layer structure or toner particles having a so-called core-shell structure formed of a core (core particle) and a coating layer (shell layer) coating the core.

The toner particle having a core-shell structure may include, for example, a core containing a binder resin and, as necessary, other additives such as a colorant and a release agent, and a coating layer containing a binder resin.

The volume-average particle size (D50v) of the toner particles is preferably 2 μm or more and 10 μm or less, more preferably 4 μm or more and 8 μm or less.

Various average particle sizes and various particle size distribution indices of the toner particles are measured using a Coulter Multisizer II (manufactured by Beckman Coulter, Inc.) and ISOTON-II (manufactured by Beckman Coulter, Inc.) as an electrolytic solution.

For the measurement, 0.5 mg or more and 50 mg or less of a measurement sample is added to 2 ml of a 5% by mass aqueous solution of a surfactant (preferably sodium alkylbenzene sulfonate) as a dispersant. The resultant is added to 100 ml or more and the 150 ml or less of the electrolytic solution.

The electrolytic solution in which the sample is suspended is subjected to a dispersion treatment for 1 minute by an ultrasonic disperser, and the particle size distribution of particles having a particle size in the range of 2 μm or more and 60 μm or less is measured by Coulter Multisizer II using an aperture having an aperture diameter of 100 m. The number of particles to be sampled is 50,000.

Cumulative distributions of volumes and numbers are plotted from the small diameter side with respect to particle size ranges (channels) divided based on the measured particle size distribution, and particle sizes at a cumulative of 16% are defined as a volumetric particle size D16v and a number particle size D16p, particle sizes at a cumulative of 50% are defined as a volume-average particle size D50v and a cumulative number-average particle size D50p, and particle sizes at a cumulative of 84% are defined as a volumetric particle size D84v and a number particle size D84p.

With these sizes, the volume-based particle size distribution indices (GSDv) are calculated as (D84v/D16v)^{1/2} and the number-based particle size distribution indices (GSDp) are calculated as (D84p/D16p)^{1/2}

The average circularity of the toner particles is preferably 0.94 or more and 1.00 or less, more preferably 0.95 or more and 0.98 or less.

The average circularity of the toner particles is obtained by (circle-equivalent perimeter)/(perimeter) [(perimeter of a circle having the same projected area as a particle image)/(perimeter of a particle projected image)]. Specifically, it is a value measured by the following method.

First, collect the toner particles to be measured by suction to form a flat flow, and capture their particle image as a still image with stroboscopic flash, then analyze the particle image with a flow particle image analyzer (FPIA-3000 manufactured by Sysmex Corporation). The number of samples used to obtain the average circularity is 3,500.

When the toner has an external additive, disperse the toner (developer) to be measured in water containing a surfactant and then perform ultrasonic treatment to obtain toner particles from which the external additive has been removed.

### [Lubricant]

Examples of the lubricant include fatty acid metal salt particles and layered structure compound particles. From the viewpoint of being excellent in the effect of suppressing the generation of color streaks, fatty acid metal salt particles are preferable.

Examples of the fatty acid metal salt include a stearic acid metal salt and a lauric acid metal salt. Examples of the stearic acid metal salt include zinc stearate, calcium stearate, barium stearate, magnesium stearate, aluminum stearate, lithium stearate, potassium stearate, and iron stearate. Examples of the lauric acid metal salt include zinc laurate, calcium laurate, barium laurate; magnesium laurate, aluminum laurate, lithium laurate, potassium laurate, and iron laurate. From the viewpoint of being excellent in the effect of suppressing the generation of color streaks, stearic acid metal salt particles are preferable, and zinc stearate particles are more preferable.

The layered structure compound is a compound having a stacked structure in which the interlayer distance is on the order of angstroms, and is considered to exhibit a lubricating action when the layers are shifted from each other. Examples of the layered structure compound include melamine cyanurate, boron nitride, graphite fluoride, molybdenum disulfide, and mica.

The volume-average particle size of the lubricant particles is preferably 0.1 μm or more and 8 μm or less, more preferably 0.2 μm or more and 5 μm or less, still more preferably 0.5 μm or more and 3 μm or less.

The volume-average particle size of the lubricant particles is determined as follows.

Place 1 g of the green toner in a 1 L beaker, then add 500 g of a 5% by mass aqueous solution of a surfactant (preferably sodium alkylbenzene sulfonate). Apply ultrasonic waves to desorb the external additive from the toner particles, and perform centrifugal separation to fractionate the lubricant particles using their density. Add 2 ml of the fractionated material containing the lubricant particles to 100 ml or 150 ml of an electrolytic solution (ISOTON-II, manufactured by Beckman Coulter, Inc.), and disperse the mixture with ultrasonic waves to prepare a measurement sample. Measure the particle sizes of 5,000 lubricant particles having a particle size of 60 μm or less using a Coulter Multisizer II (manufactured by Beckman Coulter, Inc., aperture diameter 100 m), and the particle size at which the cumulative percentage is 50% from the small diameter side in a volume-based particle size distribution is defined as the volume-average particle size.

In the green toner according to the present exemplary embodiment, when the green toner is dispersed in water containing a surfactant and subjected to ultrasonic treatment at a power of 20 W and a frequency of 20 kHz for 1 minute, the amount of the lubricant particles detached from the green toner particles is preferably from 10% by mass or more and 30% by mass or less with respect to the amount of the lubricant particles externally added to the green toner particles.

The mass proportion of the lubricant particles detached from the green toner particles by the above-described ultrasonic treatment is also referred to as a weak adhesion proportion of the lubricant particles.

When the weak adhesion proportion of the lubricant particles is 10% by mass or more, the lubricant particles are easily transferred from the green toner particles to the surface of an image holding member, and the effect of suppressing color streaks is excellent. In this respect, the weak adhesion proportion of the lubricant particles is more preferably 12% by mass or more, still more preferably 15% by mass or more.

When the weak adhesion proportion of the lubricant particles is 30% by mass or less, the amount of the lubricant particles transferred from the green toner particles to the surface of an image holding member is not excessively large, and thus filming is unlikely to be caused. In this respect, the weak adhesion proportion of the lubricant particles is more preferably 25% by mass or less, still more preferably 20% by mass or less.

The green toner according to the present exemplary embodiment preferably contains fatty acid metal salt particles as a lubricant, and when the green toner is dispersed in water containing a surfactant and subjected to ultrasonic treatment at a power of 20 W and a frequency of 20 kHz for 1 minute, the fatty acid metal salt particles detached from the green toner particles is preferably 10% by mass or more and 30% by mass or less of the fatty acid metal salt particles externally added to the green toner particles.

The mass proportion of the fatty acid metal salt particles detached from the green toner particles by the above-described ultrasonic treatment is also referred to as a weak adhesion proportion of the fatty acid metal salt particles.

When the weak adhesion proportion of the fatty acid metal salt particles is 10% by mass or more, the fatty acid metal salt particles are easily transferred from the green toner particles to the surface of an image holding member, and the effect of suppressing color streaks is excellent. In this respect, the weak adhesion proportion of the fatty acid metal salt particles is more preferably 12% by mass or more, still more preferably 15% by mass or more.

When the weak adhesion proportion of the fatty acid metal salt particles is 30% by mass or less, the amount of the fatty acid metal salt particles transferred from the green toner particles to the surface of an image holding member is not excessively large, and thus filming is unlikely to be caused. In this respect, the weak adhesion proportion of the fatty acid metal salt particles is more preferably 25% by mass or less, still more preferably 20% by mass or less.

The weak adhesion proportion of the fatty acid metal salt particles is obtained as follows. The weak adhesion proportion of the lubricant particles and the weak adhesion proportion of the lubricant particles other than the fatty acid metal salt particles are also obtained in the same manner.

Prepare an aqueous surfactant solution containing 0.5% by mass of a surfactant (NOIGEN ET-165, DKS Co., Ltd.) in ion-exchanged water. Put 50 mL of the aqueous surfactant solution into a 100 mL glass beaker, then add 4 g of the green toner, and stir the mixture with a magnetic stirring machine at a rotational speed of 100 rpm for 5 minutes to prepare a toner dispersion. Prepare two of this toner dispersion.

Insert a probe of an ultrasonic homogenizer (VCX750, Sonic and Materials, Inc.) into one toner dispersion (insert the probe tip to a 1.0 cm from the bottom of the beaker), and apply ultrasonic waves with a power of 20 W and a frequency of 20 kHz for 1 minute. Centrifuge the toner dispersion to fractionate the green toner particles, the fatty acid metal salt particles, and other external additives using their densities, and collect the fraction including the fatty acid metal salt particles. Dry the fraction, then measure the mass of the fatty acid metal salt particles. This mass is defined as S1.

Insert a probe of an ultrasonic homogenizer (VCX750, Sonic and Materials, Inc.) into the other toner dispersion (insert the probe tip to a 1.0 cm from the bottom of the beaker), and apply ultrasonic waves with a power of 100 W and a frequency of 10 kHz for 30 minutes. This ultrasonic wave intensity is an intensity at which all of the fatty acid metal salt particles can be detached from the green toner particles. Centrifuge the toner dispersion to fractionate the green toner particles, the fatty acid metal salt particles, and other external additives using their densities, and collect the fraction including the fatty acid metal salt particles. Dry the fraction, then measure the mass of the fatty acid metal salt particles. This mass (that is, the total mass of the fatty acid metal salt particles externally added to the green toner particles) is defined as S2.

The value of S1/S2×100 is defined as the weak adhesion proportion (mass %) of the fatty acid metal salt particles.

The weak adhesion proportion of the fatty acid metal salt particles can be controlled by adjusting the rotation speed and/or rotation time of the blender or the mixer during mixing of the green toner particles and the fatty acid metal salt particles.

The amount of the lubricant externally added is preferably 0.02 parts by mass or more and 5.0 parts by mass or less, more preferably 0.04 parts by mass or more and 2.0 parts by mass or less, and still more preferably 0.08 parts by mass or more and 0.5 parts by mass or less with respect to 100 parts by mass of the green toner particles.

### [Resin Particles]

The green toner according to the present exemplary embodiment preferably includes resin particles as an external additive from the viewpoint of preventing generation of color streaks in an image. Examples of the resin particles include acrylic resin particles, polystyrene resin particles, and melamine resin particles, and acrylic resin particles are preferable from the viewpoint of the mechanical strength of the particles.

The (meth)acrylic acid alkyl ester that forms the acrylic resin particles is preferably a (meth)acrylic acid alkyl ester in which the alkyl group has 1 to 6 carbon atoms. Examples of the (meth)acrylic acid alkyl ester include methyl (meth)acrylate, ethyl (meth)acrylate, propyl (meth)acrylate, butyl (meth)acrylate, and hexyl (meth)acrylate, and methyl (meth)acrylate is preferable.

The average primary particle size of the resin particles is preferably 10 nm or more and 500 nm or less, more preferably 20 nm or more and 400 nm or less, still more preferably 30 nm or more and 300 nm or less, from the viewpoint of highly uniformly coating the surfaces of the toner particles.

The average primary particle size of the resin particles is determined as follows.

Capture an image of the green toner at a magnification of 40,000 times using a scanning electron microscopy (SEM) (S-4800, manufactured by Hitachi High-Tech Corporation) equipped with an energy dispersive X-ray spectrometer (EDX apparatus, manufactured by HORIBA, Ltd., EMAX Evolution X-Max 80 mm²). Identify 200 resin particles from one field based on the presence of a carbon element by EDX analysis. Analyze the image of 200 resin particles with image processing analysis software WinRoof (MITANI CORPORATION) to determine the equivalent circle diameter of the primary particle. In the number-based distribution of the equivalent circle diameter, the equivalent circle diameter at a cumulative 50% from the small diameter side is defined as the average primary particle size.

When the green toner according to the present exemplary embodiment includes resin particles, the amount of the resin particles externally added is preferably 0.05 parts by mass or more and 1.0 parts by mass or less, more preferably 0.08 parts by mass and 0.8 parts by mass or less, and still more preferably 0.1 parts by mass or more and 0.5 parts by mass or less with respect to 100 parts by mass of the green toner particles.

When the green toner according to the present exemplary embodiment includes acrylic resin particles, the amount of the acrylic resin particles externally added is preferably 0.05 parts by mass or more and 1.0 parts by mass or less, more preferably 0.08 parts by mass or more and 0.8 parts by mass or less, and still more preferably 0.1 parts by mass or more and 0.5 parts by mass or less with respect to 100 parts by weight of the green toner particles.

### [Titanic Acid Compound Particles]

The green toner according to the present exemplary embodiment preferably includes titanic acid compound particles as an external additive from the viewpoint of preventing generation of color streaks in an image. The titanic acid compound particles have an effect of polishing the surface of an image holding member and suppress filming on the surface of the image holding member.

The titanic acid compound particles may be any particles containing a titanic acid compound as a main component. Titanic acid compounds are referred to as meta titanates and are, for example, salts produced from titanium oxide and other metal oxides or other metal carbonates.

The titanic acid compound particles are preferably alkaline earth metal titanate particles. The alkaline earth metal titanate is a salt represented by the composition formula RTiO₃ wherein R is one or two or more alkaline earth metals.

Examples of the titanic acid compound particles include particles of strontium titanate (SrTiO₃), calcium titanate (CaTiO₃), magnesium titanate (MgTiO₃), barium titanate (BaTiO₃), lead titanate (PbTiO₃), and zinc titanate (ZnTiO₃). The titanic acid compound particles may be used alone or in combination of two or more thereof.

The titanic acid compound particles may contain a dopant. Examples of the dopant include lanthanides (e.g, lanthanum, cerium), silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin.

When the titanic acid compound particles contain a dopant, the amount of the dopant is preferably 0.1 mol % or more and 20 mol % or less, more preferably 0.1 mol % or more and 15 mol % or less, still more preferably 0.1 mol % or more and 10 mol % or less with respect to the metal atoms other than titanium.

When the alkaline earth metal titanate particles contain a dopant, the amount of the dopant is preferably 0.1 mol % or more and 20 mol % or less, more preferably 0.1 mol % or more and 15 mol % or less, still more preferably 0.1 mol % or more and 10 mol % or less with respect to the alkaline earth metal atoms.

When strontium titanate particles contain a dopant, the amount of the dopant is preferably 0.1 mol % or more and 20 mol % or less, more preferably 0.1 mol % or more and 15 mol % or less, still more preferably 0.1 mol % or more and 10 mol % or less with respect to strontium.

The surface of the titanic acid compound particles may be subjected to hydrophobization treatment. Examples of the hydrophobizing agent include a silane coupling agent and silicone oil.

Examples of the silane coupling agent include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

Examples of the silicone oil include dimethyl polysiloxane, methylhydrozine polysiloxane, and methylphenyl polysiloxane.

The average primary particle size of the titanic acid compound particles is preferably 10 nm or more and 100 nm or less, more preferably 15 nm or more and 80 nm or less, still more preferably 20 nm or more and 60 nm or less, from the viewpoint of highly uniformly coating the surfaces of the toner particles.

The average primary particle size of the titanic acid compound particles is more preferably 100 nm or more and 2000 nm or less, more preferably 300 nm or more and 1800 nm or less, still more preferably 500 nm or more and 1500 nm or less, from the viewpoints of polishing the surface of an image holding member and suppressing filming of the surface of the image holding member.

The average primary particle size of the titanic acid compound particles is obtained as follows.

Capture an image of the toner at a magnification of 40,000 times using a scanning electron microscopy (SEM) (S-4800, manufactured by Hitachi High-Tech Corporation) equipped with an energy dispersive X-ray spectrometer (EDX apparatus, manufactured by HORIBA, Ltd., EMAX Evolution X-Max 80 mm²). Identify 200 titanic acid compound particles in one visual field based on the presence of a titanium element and an oxygen element with the EDX analysis. Analyze the image of 200 titanic acid compound particles with image processing analysis software WinRoof (MITANI CORPORATION). Obtain the equivalent circle diameter of the primary particles, and the equivalent circle diameter at which the cumulative percentage is 50% from the small diameter side in the distribution of equivalent circle diameters is defined as the average primary particle size.

When the green toner according to the present exemplary embodiment includes titanic acid compound particles, the amount of the titanic acid compound particles externally added is preferably 0.05 parts by mass or more and 1.0 parts by mass or less, more preferably 0.08 parts by mass or more and 0.8 parts by mass or less, and still more preferably 0.1 parts by mass or more and 0.5 parts by mass or less with respect to 100 parts by mass of the green toner particles.

When the green toner according to the present exemplary embodiment includes alkaline earth metal titanate particles, the amount of the alkaline earth metal titanate particles externally added is preferably 0.05 parts by mass or more and 1.0 parts by mass or less, more preferably 0.08 parts by mass or more and 0.8 parts by mass or less, and still more preferably 0.1 parts by mass or more and 0.5 parts by mass or less with respect to 100 parts by mass of the green toner particles.

When the green toner according to the present exemplary embodiment includes strontium titanate particles, the amount of the strontium titanate particles externally added is preferably 0.05 parts by mass or more and 1.0 parts by mass or less, more preferably 0.08 parts by mass or more and 0.8 parts by mass or less, and still more preferably 0.1 parts by mass or more and 0.5 parts by mass or less with respect to 100 parts by mass of the green toner particles.

The green toner according to the present exemplary embodiment preferably includes lubricant particles, resin particles, and titanic acid compound particles as external additives, and more preferably includes fatty acid metal salt particles, acrylic resin particles, and strontium titanate particles, from the viewpoint of preventing generation of color streaks in an image. A preferred form of each of the lubricant particles, the fatty acid metal salt particles, the resin particles, the acrylic resin particles, the titanic acid compound particles, and the strontium titanate particles is as described above.

When the green toner according to the present exemplary embodiment includes resin particles and titanic acid compound particles, the amounts of the resin particles and the titanic acid compound particles to be externally added are preferably in the following ranges.

The amount of the resin particles externally added is preferably 0.05 parts by mass or more and 1.0 parts by mass or less, more preferably 0.08 parts by mass or more and 0.8 parts by mass or less, still more preferably 0.1 parts by mass or more and 0.5 parts by mass or less with respect to 100 parts by mass of the green toner particles.

The amount of the titanic acid compound particles externally added is preferably 0.05 parts by mass or more and 1.0 parts by mass or less, more preferably 0.08 parts by mass or more and 0.8 parts by mass or less, still more preferably 0.1 parts by mass or more and 0.5 parts by mass or less with respect to 100 parts by mass of the green toner particles.

### [Other External Additives]

The green toner according to the present exemplary embodiment may include inorganic particles other than the titanic acid compound particles. Examples of the inorganic particles include inorganic particles such as SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surfaces of the above-described inorganic particles are preferably subjected to hydrophobization treatment. The hydrophobization treatment is performed, for example, by immersing the inorganic particles in a hydrophobizing agent. The hydrophobizing agent is not limited, and examples thereof include a silane coupling agent, a silicone oil, a titanate coupling agent, and an aluminum coupling agent. These may be used alone or in combination of two or more thereof.

When the green toner according to the present exemplary embodiment includes the above-described inorganic particles, the amount of the inorganic particles externally added is preferably 0.01 parts by mass or more and 5 parts by mass or less, more preferably 0.01 parts by mass or more and 2 parts by mass or less with respect to 100 parts by mass of the toner particles.

The green toner according to the present exemplary embodiment preferably includes silica particles, lubricant particles, resin particles, and titanic acid compound particles as external additives, and more preferably includes hydrophobic silica particles, fatty acid metal salt particles, acrylic resin particles, and strontium titanate particles, from the viewpoint of achieving toner fluidity, transferability to recording medium, suppression of generation of color streaks, and the like in a well-balanced manner. A preferred form of the silica particles, the hydrophobic silica particles, the lubricant particles, the fatty acid metal salt particles, the resin particles, the acrylic resin particles, the titanic acid compound particles, and the strontium titanate particles is as described above.

### [Method for Producing Green Toner]

The green toner according to the present exemplary embodiment is obtained by producing green toner particles and then externally adding an external additive to the green toner particles. The external additive includes at least a lubricant.

The green toner particles may be produced by any one of a dry process (e.g., a kneading-pulverization method) and a wet process (e.g., an aggregation-coalescence method, a suspension polymerization method, a dissolution and suspension method). These production methods are not particularly limited, and known production methods are adopted. Of these, the toner particles may be obtained by an aggregation and coalescence method.

When the green toner particles are produced by an aggregation and coalescence method, the following production method is preferable.

A production method including: a step of preparing a resin particle dispersion in which resin particles serving as a binder resin are dispersed (resin particle dispersion preparation step); a step of preparing a fluorescent pigment (Y) dispersion in which an azomethine fluorescent pigment (Y) is dispersed (fluorescent pigment (Y) dispersion preparation step); a step of preparing a pigment (G) dispersion in which a pigment (G) is dispersed (pigment (G) dispersion preparation step); a step of aggregating mixed particles in a mixed dispersion obtained by mixing the resin particle dispersion, the fluorescent pigment (Y) dispersion, and the pigment (G) dispersion to form aggregated particles (aggregated particle formation step); and a step of heating the aggregated particle dispersion in which the aggregated particles are dispersed to fuse and coalesce the aggregated particles to form green toner particles (fusion and coalescence step).

Hereinafter, details of each step will be described. In the following description, the green toner particles are simply referred to as toner particles. In the following description, a method of obtaining toner particles containing a release agent is described, but the release agent is used as necessary.

### —Resin Particle Dispersion Preparation Step—

The resin particle dispersion is prepared, for example, by dispersing resin particles in a dispersion medium with a surfactant.

Examples of the dispersion medium used for the resin particle dispersion include an aqueous medium.

Examples of the aqueous medium include water such as distilled water and ion-exchanged water, and alcohols. These medium may be used alone or in combination of two or more thereof.

Examples of the surfactant include: anionic surfactants such as sulfate surfactants, sulfonate surfactants, phosphate surfactants, and soap surfactants; cationic surfactants such as amine salt surfactants and quaternary ammonium salt surfactants; nonionic surfactants such as polyethylene glycol surfactants, alkylphenol ethylene oxide adduct surfactants, and polyhydric alcohol surfactants. Of these, in particular, anionic surfactants and cationic surfactants may be used. The nonionic surfactant may be used in combination with an anionic surfactant or a cationic surfactant.

The surfactants may be used alone or in combination of two or more thereof.

Examples of a method for dispersing resin particles in a dispersion medium to prepare the resin particle dispersion includes common dispersion methods that use a rotary shear homogenizer or a mill containing media such as a ball mill, a sand mill, or a Dyno-Mill. Depending on the type of the resin particles, the resin particles may be dispersed in the dispersion medium by a phase inversion emulsification method. The phase inversion emulsification method is a method in which a resin to be dispersed is dissolved in a hydrophobic organic solvent in which the resin is soluble, a base is added to an organic continuous phase (O phase) for neutralization, and then an aqueous medium (W phase) is charged, to perform phase inversion from W/O to O/W, and in this method, a resin is dispersed in an aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less. The volume-average particle size of the resin particles is measured as follows: drawing a volume-based cumulative distribution in divided particle size ranges (channels) from the smaller particle diameter side using the particle size distribution obtained by measurement with a laser diffraction particle size distribution analyzer (for example, LA-700 manufactured by HORIBA, Ltd.); and defining the particle size at a cumulative percentage of 50% with respect to all particles as a volume-average particle size D50v. The volume-average particle sizes of the particles in other dispersions are also measured in the same manner.

The content of the resin particles contained in the resin particle dispersion is, for example, preferably 5% by mass or more and 50% by mass or less, more preferably 10% by mass or more and 40% by mass or less.

The method for preparing the release agent particle dispersion is the same as that for the resin particle dispersion. The content of the release agent particles included in the release agent particle dispersion is preferably 5% by mass or more and 50% by mass or less, more preferably 10% by mass or more and 40% by mass or less.

### —Fluorescent Pigment (Y) Dispersion Preparation Step—

The fluorescent pigment (Y) dispersion is prepared, for example, by dispersing the azomethine fluorescent pigment (Y) in a dispersion medium with a surfactant.

Examples of the dispersion medium used for the fluorescent pigment (Y) dispersion include an aqueous medium.

Examples of the aqueous medium include water such as distilled water and ion-exchanged water, and alcohols. These medium may be used alone or in combination of two or more thereof.

Examples of the surfactant include: anionic surfactants such as sulfate surfactants, sulfonate surfactants, phosphate surfactants, and soap surfactants; cationic surfactants such as amine salt surfactants and quaternary ammonium salt surfactants; nonionic surfactants such as polyethylene glycol surfactants, alkylphenol ethylene oxide adduct surfactants, and polyhydric alcohol surfactants. Of these, in particular, anionic surfactants and cationic surfactants may be used. The nonionic surfactant may be used in combination with an anionic surfactant or a cationic surfactant.

The surfactants may be used alone or in combination of two or more thereof.

Examples of the method for dispersing the azomethine fluorescent pigment (Y) in the dispersion medium include a dispersion method using a rotary shear homogenizer or a mill containing media such as a ball mill, a sand mill, a Dyno-Mill, a key mill, or the like.

The volume-average particle size of the azomethine fluorescent pigment (Y) dispersed in the fluorescent pigment (Y) dispersion is, for example, preferably 30 nm or more and 800 nm or less, more preferably 50 nm or more and 650 nm or less, still more preferably 150 nm or more and 600 nm or less, and still more preferably 250 nm or more and 400 nm or less. The particle size of the azomethine fluorescent pigment (Y) can be adjusted, for example, by the method and time for the dispersion treatment.

The content of the azomethine fluorescent pigment (Y) contained in the fluorescent pigment (Y) dispersion is preferably 5% by mass or more and 50% by mass or less, more preferably 10% by mass or more and 40% by mass or less.

### —Pigment (G) Dispersion Preparation Step—

The pigment (G) dispersion is prepared, for example, by dispersing the pigment (G) in a dispersion medium with a surfactant.

Examples of the dispersion medium used for the pigment (G) dispersion include an aqueous medium.

Examples of the aqueous medium include water such as distilled water and ion-exchanged water, and alcohols. These medium may be used alone or in combination of two or more thereof.

Examples of the surfactant include: anionic surfactants such as sulfate surfactants, sulfonate surfactants, phosphate surfactants, and soap surfactants; cationic surfactants such as amine salt surfactants and quaternary ammonium salt surfactants; nonionic surfactants such as polyethylene glycol surfactants, alkylphenol ethylene oxide adduct surfactants, and polyhydric alcohol surfactants. Of these, in particular, anionic surfactants and cationic surfactants may be used. The nonionic surfactant may be used in combination with an anionic surfactant or a cationic surfactant.

The surfactants may be used alone or in combination of two or more thereof.

Examples of the method for dispersing the pigment (G) in the dispersion medium include a dispersion method using a rotary shear homogenizer or a mill containing media such as a ball mill, a sand mill, a Dyno-Mill, a key mill, or the like.

The volume-average particle size of the pigment (G) dispersed in the pigment (G) dispersion is, for example, preferably 20 nm or more and 400 nm or less, more preferably 50 nm or more and 300 nm or less, still more preferably 100 nm or more and 250 nm or less, still more preferably 120 nm or more and 200 nm or less. The particle size of the pigment (G) can be adjusted by, for example, the method and time for dispersion treatment.

The content of the pigment (G) contained in the pigment (G) dispersion is preferably 5% by mass or more and 50% by mass or less, more preferably 10% by mass or more and 40% by mass or less.

### —Aggregated Particle Formation Step—

The resin particle dispersion, the fluorescent pigment (Y) dispersion, the pigment (G) dispersion, and the release agent particle dispersion are mixed. Then, the resin particles, the azomethine fluorescent pigment (Y), the pigment (G), and the release agent particles are heteroaggregated in the mixed dispersion to form aggregated particles having a diameter close to the diameter of the target toner particles and containing the resin particles, the azomethine fluorescent pigment (Y), the pigment (G), and the release agent particles.

Specifically, the aggregated particles are formed for example by adding a flocculant to the mixed dispersion, adjusting the pH of the mixed dispersion to be acidic (for example, a pH of 2 or more and 5 or less), adding a dispersion stabilizer as necessary, thereafter heating the mixture to a temperature close to the glass transition temperature of the resin particles (specifically, for example, the glass transition temperature of the resin particles minus 30° C. or more and minus 10° C. or less) to cause aggregation of the particles dispersed in the mixed dispersion.

The aggregated particle formation step may include, for example, adding the flocculant to the mixed dispersion at room temperature (for example, 25° C.) under stirring with a rotary shear homogenizer and adjusting the pH of the mixed dispersion to the acid side (for example, a pH of 2 or more and 5 or less), and heating the mixed dispersion after addition of a dispersion stabilizer as necessary.

Examples of the flocculant include a surfactant having a polarity opposite to the polarity of the surfactant included in the mixed dispersion, an inorganic metal salt, and a dihydric or higher metal complex. The use of a metal complex as the flocculant reduces the use amount of the surfactant and improves the charging characteristics.

An additive that forms a complex or similar bond with metal ions of the flocculant may be used with the flocculant, as necessary. A chelating agent is suitably used as the additive.

Examples of the inorganic metal salt include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent may be a water-soluble chelating agent. Examples of the chelating agent include: oxycarboxylic acids such as tartaric acid, citric acid, and gluconic acid; and aminocarboxylic acids such as iminodiacetic acid (IDA), nitrilotriacetic acid (NTA), and ethylene diamine tetraacetic acid (EDTA).

The addition amount of the chelating agent is preferably 0.01 parts by mass or more and 5.0 parts by mass or less, more preferably 0.1 parts by mass or more and less than 3.0 parts by mass with respect to 100 parts by mass of the resin particles.

### —Fusion and Coalescence Step—

Next, the aggregated particle dispersion in which the aggregated particles are dispersed is heated, for example, to a temperature equal to or higher than the glass transition temperature of the resin particles (for example, a temperature higher than the glass transition temperature of the resin particles by 10° C. to 30° C.) to fuse and coalesce the aggregated particles, thereby forming toner particles.

The toner particles are obtained through the above-described steps.

The toner particles may also be produced through the following steps: a step of, after obtaining an aggregated particle dispersion in which aggregated particles are dispersed, further mixing the aggregated particle dispersion with a resin particle dispersion in which resin particles are dispersed, to cause aggregation such that the resin particles adhere to the surfaces of the aggregated particles and thus to form second aggregated particles, and a step of heating second aggregated particle dispersion in which the second aggregated particles are dispersed to cause fusion and coalescence of the second aggregated particles and thus to form toner particles having a core-shell structure.

After completion of the fusion and coalescence step, the toner particles in the dispersion liquid are subjected to known washing step, solid-liquid separation step, and drying step to obtain dried toner particles. In the washing step, displacement washing with ion-exchanged water may be sufficiently performed from the viewpoint of chargeability. In the solid-liquid separation step, suction filtration, pressure filtration, or the like may be performed from the viewpoint of productivity. In the drying step, freeze drying, flash drying, fluidized drying, vibration-type fluidized drying, or the like may be performed from the viewpoint of productivity.

The toner according to the exemplary embodiment is produced by, for example, adding an external additive to the obtained toner particles in a dried state. The mixing may be performed with, for example, a V blender, a Henschel mixer, or a Loedige mixer. Coarse particles in the toner may be removed with a vibratory screening machine, a wind-power screening machine, or the like as necessary.

When the toner particles and the lubricant are mixed, the weak adhesion proportion of the lubricant is controlled by adjusting the rotation speed and/or the rotation time of the blender or the mixer.

### <Electrostatic Charge Image Developer>

The electrostatic charge image developer according to the present exemplary embodiment includes at least the green toner according to the present exemplary embodiment.

The electrostatic charge image developer according to the exemplary embodiment may be a one component developer containing only the green toner according to the exemplary embodiment, or a two component developer in which the green toner and a carrier are mixed.

The carrier is not particularly limited, and examples thereof include known carriers. Examples of the carrier include: a coated carrier including a core material including magnetic powder whose surface is coated with resin; a magnetic powder-dispersed carrier in which a magnetic powder is blended in a dispersed state in matrix resin; and a resin-impregnated carrier in which porous magnetic powder is impregnated with resin.

The magnetic powder-dispersed carrier and the resin-impregnated carrier may be carriers in which the surfaces of carrier-forming particles serving as core materials are coated with resin.

Examples of the magnetic powder include powders made of magnetic metal such as iron, nickel, or cobalt, and powders made of magnetic oxide such as ferrite or magnetite.

Examples of the resin for coating and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin having an organosiloxane bond or a modified product thereof, fluororesin, polyester, polycarbonate, phenolic resin, epoxy resin, and acrylic resin.

As the resin for coating, an acrylic resin is preferable, and an acrylic resin having an alicyclic structure is more preferable from the viewpoint of the chargeability of the carrier.

The mass proportion of the acrylic resin in the entire resin of the resin for coating is preferably 50% by mass or more, more preferably 80% by mass or more.

The mass proportion of the acrylic resin having an alicyclic structure in the entire resin of the resin for coating is preferably 50% by mass or more, more preferably 80% by mass or more.

The acrylic resin having an alicyclic structure preferably contains cyclohexyl (meth)acrylate as a polymerization component. The mass proportion of cyclohexyl (meth)acrylate in all the polymerization components is preferably 75% by mass or more and 100% by mass or less, more preferably 85% by mass or more and 100% by mass or less, still more preferably 95% by mass or more and 100% by mass or less.

As a polymerization component other than cyclohexyl (meth)acrylate constituting the acrylic resin having an alicyclic structure, a lower alkyl ester of (meth)acrylic acid (for example, a (meth)acrylic acid alkyl ester in which the carbon number of the alkyl group is 1 or more and 9 or less) is preferable. Examples of the lower alkyl ester of (meth)acrylic acid include methyl (meth)acrylate, ethyl (meth)acrylate, propyl (meth)acrylate, butyl (meth)acrylate, hexyl (meth)acrylate, and 2-ethylhexyl (meth)acrylate. These monomers may be used alone or in combination of two or more thereof.

The resin for coating preferably further contains a nitrogen-containing (meth)acrylate resin. The nitrogen-containing (meth)acrylate resin preferably has an amino group.

Examples of the nitrogen-containing (meth)acrylate resin include: homopolymers or copolymers of nitrogen-containing (meth)acrylates such as dimethylaminomethyl (meth)acrylate, dimethylaminoethyl (meth)acrylate, and dibutylaminomethyl (meth)acrylate; copolymers of a nitrogen-containing (meth)acrylate and a nitrogen-free monomer; and copolymers of a nitrogen-free (meth)acrylate such as cycloalkyl (meth)acrylate and alkyl (meth)acrylate and a nitrogen-containing monomer.

The resin for coating and the matrix resin may contain other additives such as conductive particles. Examples of the conductive particles include particles made of metal such as gold, silver, or copper, carbon black, titanium oxide, zinc oxide, tin oxide, barium sulfate, aluminum borate, and potassium titanate. Examples of other additives include silica particles. The surface of these particles may be subjected to hydrophobization treatment.

The average particle size of these particles is preferably 5 nm or more and 90 nm or less, more preferably 5 nm or more and 70 nm or less, still more preferably 8 nm or more and 50 nm or less.

To coat the surface of the core material with resin, a method of coating the surface with a coating layer forming solution in which a resin for coating and various additives (used as necessary) are dissolved in an appropriate solvent, and the like are exemplified. The solvent is not particularly limited, and may be selected in consideration of the type of the resin to be used, application suitability, and the like.

Specific examples of the resin covering method include: an immersion method including immersing the core material in the coating layer forming solution; a spray method including spraying the coating layer forming solution to the surface of the core material; a fluidized bed method including spraying the coating layer forming solution while the core material is floating in air flow; and a kneader-coater method including mixing the core material of the carrier and the coating layer forming solution in a kneader-coater and then removing a solvent.

The mixing ratio (mass ratio) between the green toner and the carrier in the two component developer is preferably green toner:carrier=1:100 to 30:100, more preferably 3:100 to 20:100.

### <Image Forming Apparatus and Image Forming Method>

An image forming apparatus and an image forming method according to the present exemplary embodiment will be described.

The image forming apparatus according to the exemplary embodiment includes an image holding member, a charging unit that charges a surface of the image holding member, an electrostatic charge image forming unit that forms an electrostatic charge image on the charged surface of the image holding member, a developing unit that contains an electrostatic charge image developer and develops, as a toner image, the electrostatic charge image formed on the surface of the image holding member by using the electrostatic charge image developer, a transfer unit that transfers the toner image formed on the surface of the image holding member onto a surface of a recording medium, and a fixing unit that fixes the toner image transferred onto the surface of the recording medium. The electrostatic charge image developer according to the exemplary embodiment is used as the electrostatic charge image developer.

An image forming method (the image forming method according to the exemplary embodiment) is performed in the image forming apparatus according to the exemplary embodiment, the method including a charging step of charging a surface of an image holding member, an electrostatic charge image forming step of forming an electrostatic charge image on the charged surface of the image holding member, a developing step of developing the electrostatic charge image formed on the surface of the image holding member by using the electrostatic charge image developer according to the exemplary embodiment to form a toner image, a transfer step of transferring the toner image formed on the surface of the image holding member onto a surface of a recording medium, and a fixing step of fixing the toner image transferred onto the surface of the recording medium.

The image forming apparatus according to the exemplary embodiment maybe a known image forming apparatuses such as: a direct transfer apparatus that directly transfers a toner image formed on the surface of an image holding member onto a recording medium; an intermediate transfer apparatus that primarily transfers a toner image formed on the surface of an image holding member onto the surface of an intermediate transfer body and secondarily transfers the toner image transferred onto the surface of the intermediate transfer body onto a surface of a recording medium; an apparatus including a cleaning unit that cleans the surface of an image holding member before charging after transfer of a toner image; and an apparatus including a charge eliminating unit that eliminates charges by irradiating the surface of an image holding member with charge eliminating light before charging after transfer of a toner image.

When the image forming apparatus according to the exemplary embodiment is an intermediate transfer apparatus, the transfer unit may include, for example, an intermediate transfer body onto which a toner image is to be transferred, a primary transfer unit that primarily transfers the toner image on the surface of the image holding member onto the surface of the intermediate transfer body, and a secondary transfer unit that secondarily transfers the toner image on the surface of the intermediate transfer body onto a surface of a recording medium.

In the image forming apparatus according to the exemplary embodiment, for example, a part including the developing unit may have a cartridge structure (process cartridge) detachably attached to the image forming apparatus. As the process cartridge, for example, a process cartridge that contains the electrostatic charge image developer according to the exemplary embodiment and includes a developing unit is suitably used.

Hereinafter, an example of the image forming apparatus according to the exemplary embodiment will be described, but the image forming apparatus is not limited to this example. In the following description, main parts illustrated in the drawings will be described, and description of other parts will be omitted.

In the following description, a six-tandem-type image forming apparatus in which six image forming units are arranged will be described as an example of the image forming apparatus according to the exemplary embodiment. The tandem-type image forming apparatus is not limited to this apparatus, and may be a five-tandem-type image forming apparatus in which five image forming units are arranged, a four-tandem-type image forming apparatus in which four image forming units are arranged, or the like.

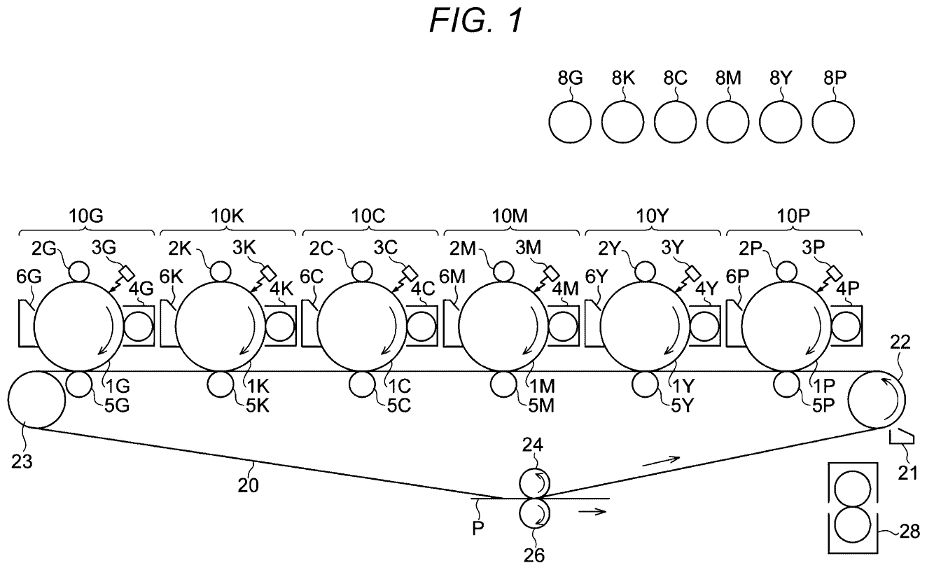

FIG. 1 is a schematic configuration diagram illustrating the image forming apparatus according to the exemplary embodiment, which is a six-tandem intermediate transfer image forming apparatus.

The image forming apparatus illustrated in FIG. 1 includes first to sixth image forming units 10P, 10Y, 10M, 10C, 10K, and 10G which are electrophotographic image forming units for outputting images of respective colors of pink (P), yellow (Y), magenta (M), cyan (C), black (K), and green (G) based on a color-separated image data. These image forming units (hereinafter may be simply referred to as “units”) 10P, 10Y, 10M, 10C, 10K, and 10G are horizontally disposed side by side at predetermined intervals. These units 10P, 10Y, 10M, 10C, 10K, and 10G may be process cartridges detachably attached to the image forming apparatus.

An intermediate transfer belt (an example of an intermediate transfer body) 20 is disposed below each of the units 10P, 10Y, 10M, 10C, 10K, and 10G to extend through the unit.

The intermediate transfer belt 20 is wound around a drive roller 22, a support roller 23, and a counter roller 24 that are disposed in contact with the inner surface of the intermediate transfer belt 20 and runs in the direction from the first unit 10P toward the sixth unit 10G. On the image holding surface side of the intermediate transfer belt 20, an intermediate transfer member cleaning device 21 is provided facing the drive roller 22.

Developing devices (examples of developing units) 4P, 4Y, 4M, 4C, 4K, and 4G of the units 10P, 10Y, 10M, 10C, 10K, and 10G are respectively supplied with pink, yellow, magenta, cyan, black, and green toners contained in the toner cartridges 8P, 8Y, 8M, 8C, 8K, and 8G.

Since the first to sixth units 10P, 10Y, 10M, 10C, 10K, and 10G have the same configuration and operation, the sixth unit 10G that forms a green image will be described as a representative example.

The sixth unit 10G has a photoreceptor 1G serving as an image holding member. The photoreceptor 1G is surrounded by, in sequence, a charging roller (an example of the charging unit) 2G that charges the surface of the photoreceptor 1G to a predetermined potential, an exposure device (an example of the electrostatic charge image forming unit) 3G that exposes the charged surface to a laser beam based on a color-separated image signal to form an electrostatic charge image, a developing device (an example of the developing unit) 4G that supplies a toner to the electrostatic charge image to develop the electrostatic charge image, a primary transfer roller (an example of the primary transfer unit) 5G that transfers the developed toner image onto the intermediate transfer belt 20, and a photoreceptor cleaning device (an example of the cleaning unit) 6G that removes toner remaining on the surface of the photoreceptor 1G after the primary transfer.

The primary transfer roller 5G is disposed on the inner side of the intermediate transfer belt 20 to face the photoreceptor 1G. Primary transfer rollers 5Y, 5P, 5M 5C, 5G, and 5K in the units are connected to respective bias power supplies (not illustrated) that apply a primary transfer bias. Each bias power supply varies a transfer bias to be applied to each primary transfer roller under the control of a control part (not illustrated).

Hereinafter, an operation of the sixth unit 10G in forming a green image will be described.

First, prior to the operation, the charging roller 2G charges the surface of the photoreceptor 1G to a potential of −600 V to −800 V.

The photoreceptor 1G includes a conductive (for example, a volume resistivity of 1×10⁻⁶ Ωcm or less at 20° C.) base material and a photosensitive layer stacked on the base material.

The photosensitive layer usually has high resistance (resistance of a common resin), but irradiation with a laser beam changes the specific resistance of a region of the photosensitive layer irradiated with the laser beam. For this, the charged surface of the photoreceptor 1G is irradiated with a laser beam from the exposure device 3G according to image data for green sent from the control part (not illustrated). This causes an electrostatic charge image with a green image pattern to form on the surface of the photoreceptor 1G.

The electrostatic charge image is an image formed on the surface of the photoreceptor 1G through charging, and it is a so-called negative latent image formed when the specific resistance of an irradiated part of the photosensitive layer is reduced by the laser beam from the exposure device 3G, charges on the surface of the photoreceptor 1G flow, and charges in a part that is not irradiated with the laser beam remain.

The electrostatic charge image formed on the photoreceptor 1G rotates up to a predetermined developing position as the photoreceptor 1G runs. At this developing position, the electrostatic charge image on the photoreceptor 1G is developed and visualized as a toner image by the developing device 4G.

The developing device 4G contains, for example, an electrostatic charge image developer containing at least green toner and a carrier. The green toner is triboelectrically charged by being stirred in the developing device 4G, and is held on a developer roller (an example of a developer holding body) having charges with the same polarity (negative polarity) as the charges on the photoreceptor 1G. As the surface of the photoreceptor 1G passes through the developing device 4G, the green toner electrostatically adheres to the charge-eliminated latent image part on the surface of the photoreceptor 1G, and a latent image is developed by the green toner. The photoreceptor 1G on which the green toner image is formed continuously runs at a predetermined speed to convey the developed toner image on the photoreceptor 1G to a predetermined primary transfer position.

When the green toner image on the photoreceptor 1G is conveyed to the primary transfer position, a primary transfer bias is applied to the primary transfer roller 5G, an electrostatic force from the photoreceptor 1G toward the primary transfer roller 5G acts on the toner image, and the toner image on the photoreceptor 1G is transferred onto the intermediate transfer belt 20. The transfer bias applied at this time has the polarity (+) opposite to the polarity (−) of the toner. The transfer bias is controlled to, for example, +10 μA in the first unit 10G by the control part (not illustrated).

The photoreceptor 1G after the toner image is transferred onto the intermediate transfer belt 20 continues rotating and comes into contact with the cleaning blade included in the photoreceptor cleaning device 6G. The toner remaining on the photoreceptor 1G is removed and collected by the photoreceptor cleaning device 6G.

The intermediate transfer belt 20 is sequentially conveyed through the first to sixth image forming units 10P, 10Y, 10M, 10C, 10K, and 10G, and the toner images of the respective colors are multiply transferred in a superimposed manner.

The intermediate transfer belt 20 onto which the toner images of the six colors have been multiply transferred through the first to sixth units reaches a secondary transfer part including the intermediate transfer belt 20, the counter roller 24 in contact with the inner surface of the intermediate transfer belt, and a secondary transfer roller (an example of the secondary transfer unit) 26 provided on the image holding surface side of the intermediate transfer belt 20. A recording paper (an example of the recording medium) P is fed to a gap between the secondary transfer roller 26 and the intermediate transfer belt 20 in contact with each other through a supply mechanism at a predetermined timing, and a secondary transfer bias is applied to the counter roller 24. The transfer bias applied at this time has the same polarity (−) as the polarity (−) of the toner. An electrostatic force from the intermediate transfer belt 20 toward the recording paper P acts on the toner image, whereby the toner image on the intermediate transfer belt 20 is transferred onto the recording paper P. The secondary transfer bias at this time is determined according to the resistance detected by a resistance detection unit (not illustrated) that detects the resistance of the secondary transfer part. The voltage for the secondary transfer bias is controlled.

The intermediate transfer belt 20 after transferring the toner image onto the recording paper P continues running, and comes into contact with the cleaning blade included in the intermediate transfer member cleaning device 21. The toner remaining on the intermediate transfer belt 20 is removed and collected by the intermediate transfer member cleaning device 21.

The recording paper P onto which the toner image has been transferred is sent to a pressure contact part (nip part) between a pair of fixing rollers in a fixing device (an example of the fixing unit) 28, and the toner image is fixed to the recording paper P to form a fixed image.

Examples of the recording paper P onto which the toner image is transferred include plain paper used in electrophotographic copying machines, printers, and the like. Examples of the recording medium include OHP sheets in addition to the recording paper P.

To further improve the smoothness of the image surface after fixing, the recording paper P preferably has a smooth surface, and for example, coated paper obtained by coating the surface of plain paper with a resin or the like and art paper for printing are suitably used.

The recording paper P to which the color image has been fixed is sent toward a discharge unit, and a series of color image forming operations ends.

### <Process Cartridge, Toner Cartridge>

A process cartridge according to the present exemplary embodiment will be described.

The process cartridge according to the exemplary embodiment is a process cartridge including a developing unit that contains the electrostatic charge image developer according to the exemplary embodiment and develops, as a toner image, an electrostatic charge image formed on the surface of an image holding member by using the electrostatic charge image developer.

The process cartridge according to the exemplary embodiment is detachably attached to an image forming apparatus.

The process cartridge according to the exemplary embodiment is not limited to the above-described configuration, and it may include a developing unit, and as necessary, at least one selected from other units, such as an image holding member, a charging unit, an electrostatic charge image forming unit, and a transfer unit, for example.

Hereinafter, an example of the process cartridge according to the exemplary embodiment will be described, but the process cartridge is not limited to this example. In the following description, main parts illustrated in the drawings will be described, and description of other parts will be omitted.

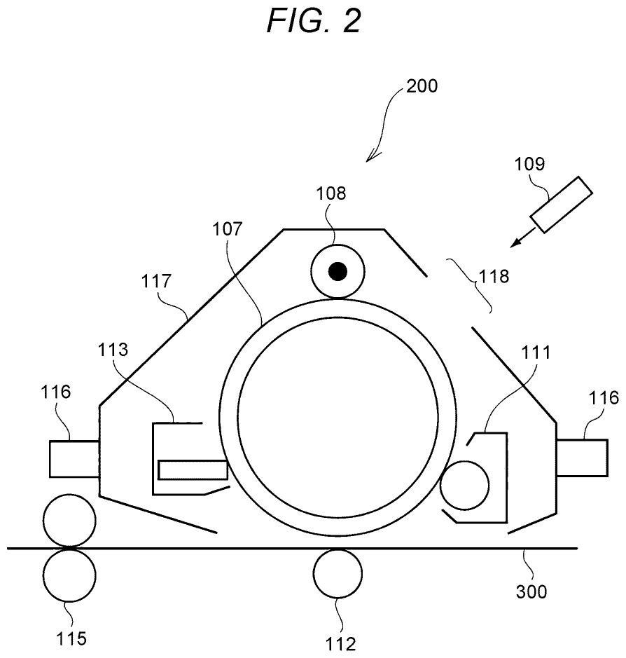

FIG. 2 is a schematic diagram illustrating the process cartridge according to the exemplary embodiment.

A process cartridge 200 illustrated in FIG. 2 is a cartridge in which, for example, a photoreceptor 107 (an example of the image holding member), a charge roller 108 (an example of the charging unit) provided around the photoreceptor 107, a developing device 111 (an example of the developing unit), and a photoreceptor cleaning device 113 (an example of the cleaning unit) are integrally combined and held by a housing 117 provided with an installation rail 116 and an opening 118 for exposure.

In FIG. 2, the reference 109 denotes an exposure device (an example of the electrostatic charge image forming unit), the reference 112 denotes a transfer device (an example of the transfer unit), the reference 115 denotes a fixing device (an example of the fixing unit), and the reference 300 denotes recording paper (an example of the recording medium).

Next, a toner cartridge according to the present exemplary embodiment will be described.

The toner cartridge according to the exemplary embodiment contains the green toner according to the exemplary embodiment. The toner cartridge is detachably attached to an image forming apparatus. The toner cartridge contains toner for replenishment to be supplied to the developing unit in the image forming apparatus.

The image forming apparatus illustrated in FIG. 1 includes detachable toner cartridges 8Y, 8P, 8M, 8C, 8G, and 8K. The developing devices 4Y, 4P, 4M, 4C, 4G, and 4K are connected to the respective toner cartridges corresponding to the colors through toner supply pipes (not illustrated). When the toner contained in the toner cartridges run short, these toner cartridges are replaced. An example of the toner cartridge according to the exemplary embodiment is the toner cartridge 8G, in which the green toner according to the exemplary embodiment is contained. The toner cartridges 8P, 8Y, 8M, 8C, and 8K contain toners of pink, yellow, magenta, cyan, and black, respectively.

### EXAMPLES

Hereinafter, exemplary embodiments of the present invention will be described in detail with reference to examples, but exemplary embodiments of the present invention are not limited to these examples.

In the following description, “part” and “%” are based on mass unless otherwise specified.

The synthesis, treatment, production, and the like are performed at room temperature (25° C.±3° C.) unless otherwise specified.

### <Production of Carrier>

Cyclohexyl methacrylate resin (weight-average molecular weight 50,000): 54 parts
Carbon black (Cabot Corporation, VXC72): 6 parts
Toluene: 250 parts
Isopropyl alcohol: 50 parts

The above materials and glass beads (diameter 1 mm, the same amount as toluene) are charged into a sand mill and stirred at a rotation speed of 190 rpm for 30 minutes to obtain a coating agent.

Into a kneader, 1,000 parts of ferrite particles (volume-average particle diameter 35 m) and 150 parts of the coating agent are charged and mixed at room temperature (25° C.) for 20 minutes. Subsequently, the mixture is heated to 75° C. and depressurized to be dried. The dried product is cooled to room temperature (25° C.), taken out from the kneader, and sieved with a mesh having an opening of 75 μm to remove coarse powder, whereby a carrier is obtained.

### Example 1: Green Toner and Green Developer

### [Preparation of Resin Particle Dispersion Liquid (1)]

Terephthalic acid: 30 parts by mole
Fumaric acid: 70 parts by mole
Bisphenol A ethylene oxide adduct: 5 parts by mole
Bisphenol A propylene oxide adduct: 95 parts by mole

The above materials are charged into a flask equipped with a stirrer, a nitrogen inlet tube, a temperature sensor, and a rectifying column, and the temperature is raised to 220° C. over 1 hour. After it is confirmed that the reaction system is uniformly stirred, 1 part of titanium tetraethoxide is added to 100 parts of the above materials. The temperature is raised to 230° C. over 30 minute while generated water is distilled off. The stirring is continued at a temperature of 230° C. for 1 hour, and then the inside of the reaction system is cooled to room temperature. An amorphous polyester resin (weight-average molecular weight 18,000, glass transition temperature 60° C.) is thus obtained.

After 40 parts of ethyl acetate and 25 parts of 2-butanol are put into a reaction vessel equipped with a temperature control unit and a nitrogen substitution unit and mixed, 100 parts of the amorphous polyester resin is gradually put thereinto and dissolved. Subsequently, 3 molar equivalents of a 10% aqueous ammonia solution with respect to the acid value of the amorphous polyester resin is added, and the mixture is stirred for 30 minutes. Subsequently, the inside of the reaction vessel is replaced with dry nitrogen, and 400 part of ion-exchanged water is added dropwise at a rate of 2 parts/min while the contents of the reaction vessel are stirred and maintained at a temperature of 40° C. to prepare a resin particle dispersion liquid. The resin particle dispersion liquid is cooled to room temperature and bubbled with dry nitrogen gas for 48 hours with stirring to remove ethyl acetate and 2-butanol to 1,000 ppm or less. Ion exchanged water is added to the resin particle dispersion liquid to obtain a resin particle dispersion liquid (1) having a solid content of 20%.

### [Preparation of Release Agent Particle Dispersion Liquid (1)]

Paraffin wax (HNP-9, NIPPON SEIRO CO., LTD.): 100 parts
Anionic surfactant (NEOGEN RK, DKS Co., Ltd.): 1 part
Ion exchange water: 350 parts

The above materials are mixed, heated to 100° C., and dispersed with a homogenizer (ULTRA-TURRAX T50, TKA Works, Inc.), and then subjected to dispersion treatment with a pressure-ejection type homogenizer (Gaulin, Inc.). When the volume-average particle size becomes 200 nm, the particles are collected to obtain a release agent particle dispersion liquid (1) having a solid content of 20%.

### [Preparation of Pigment Dispersion Liquid (Y101)]

C. I. Pigment Yellow 101: 70 parts
Anionic surfactant (NEOGEN RK, DKS Co., Ltd.): 30 parts (solid content 20%)
Ion exchange water: 200 parts

The above materials are mixed and pulverized with a continuous key mill (KMC-3, Inoue Seisakusho Co., Ltd.) until the mixture has a volume-average particle size of 300 nm. The solid content is adjusted to 20%, whereby a pigment dispersion liquid (Y101) is obtained.

### [Preparation of Pigment Dispersion Liquid (PG36)]

C. I. Pigment Green 36: 70 parts
Anionic surfactant (NEOGEN RK, DKS Co., Ltd.): 30 parts (solid content 20%)
Ion exchange water: 200 parts

The above materials are mixed and pulverized with a continuous key mill (KMC-3, Inoue Seisakusho Co., Ltd.) until the mixture has a volume-average particle size of 150 nm. The solid content is adjusted to 20%, whereby a pigment dispersion liquid (PG36) is obtained.

### [Production of Green Toner Particles]

Resin particle dispersion liquid (1): 560 parts (solid content 20%)
Release agent particle dispersion liquid (1): 30 parts (solid content 20%)
Pigment dispersion liquid (Y101): 70 parts (solid content 20%)
Pigment dispersion liquid (PG36): 30 parts (solid content 20%)
Anionic surfactant (NEOGEN RK, DKS Co., Ltd.): 12 parts (solid content 20%)

The above materials are placed in a round-bottom stainless steel flask, 0.1 mol/L nitrate is added to adjust the pH to 3.5, and 30 parts of nitrate with a polyaluminum chloride concentration of 10% is added. The liquid temperature is adjusted to 30° C., a dispersion treatment is performed by using a homogenizer (ULTRA-TURRAX T50, IKA Works, Inc.), the mixture is heated to 45° C. with a heating oil bath while stirring the inside of the flask, and the mixture is held for 30 minutes. Subsequently, 50 parts of the resin particle dispersion liquid (1) (solid content 20%) are added and held for 1 hour, thereafter the pH is adjusted to 8.5 using 0.1 mol/L sodium hydroxide solution, then the mixture is heated to 84° C. with continued stirring and held for 2.5 hours. Subsequently, the mixture is cooled to room temperature at a rate of 20° C./min, subjected to solid-liquid separation, and sufficiently washed with ion exchanged water. The solid content is subjected to vacuum drying, whereby green toner particles (1) is obtained. The volume-average particle diameter of the green toner particles (1) is 5.8 m.

### [Production of Green Toner and Green Developer]

Green toner particles (1): 100 parts
Hydrophobic silica particles (Nippon Aerosil Co., Ltd., RY50): 3.0 parts
Polymethyl methacrylate resin particles (average primary particle size 300 nm): 0.2 parts
Strontium titanate particles (average primary particle size 1,500 nm): 0.2 parts
Zinc-stearate particles (volume-average particle size 1,500 nm): 0.1 parts

The total amount of the green toner particles (1), the hydrophobic silica particles, the polymethyl methacrylate particles, and the strontium titanate particles, and a half amount of the zinc stearate particles are put into a sample mill and mixed at a rotation speed 10,000 rpm for 30 seconds. The remaining amount of zinc stearate particles is then added to the sample mill and mixed at a rotation speed 10,000 rpm for 30 seconds.

Thereafter, the mixture is sieved with a vibration sieve having an opening of 45 m, whereby an external addition toner is obtained.

Ten parts of the external addition toner and 100 parts of the carrier are placed in a V-blender and stirred for 20 minutes. Thereafter, the resultant is sieved through a sieve having an opening of 212 m, whereby a green developer is obtained.

### Comparative Example 1

Green toner particles, a green toner, and a green developer are produced in the same manner as in Example 1 except that the zinc stearate particles are not externally added.

### Example 2

Green toner particles, a green toner, and a green developer are produced in the same manner as in Example 1 except that C. I. Pigment Green 36 is replaced with C. I. Pigment Green 59 in the production of the green toner particles.

### Example 3

Green toner particles, a green toner, and a green developer are produced in the same manner as in Example 1 except that the zinc stearate particles are replaced with boron nitride particles (volume-average particle size 1,200 nm).

### Examples 4 to 7

Green toner particles, a green toner, and a green developer are produced in the same manner as in Example 1 except that the amount of zinc stearate particles externally added is changed to the specifications described in Table 1.

### Example 8

Green toner particles, a green toner, and a green developer are produced in the same manner as in Example 1 except that the sample mill treatment during the mixing of the green toner particles and the external additive is changed to 60 seconds and one time (that is, the addition of the zinc stearate particles is not divided into two times but is performed one time).

### Example 9

Green toner particles, a green toner, and a green developer are prepared in the same manner as in Example 1 except that the sample mill treatment during the mixing of the green toner particles and the external additive is changed to 45 seconds and one time (that is, the addition of the zinc stearate particles is not divided into two times but is performed one time).

### Example 10

Green toner particles, a green toner, and a green developer are produced in the same manner as in Example 1 except that the time periods of the sample mill treatment when the green toner particles and the external additive are mixed are changed to 30 seconds for the first time and 25 seconds for the second time.

### Example 11

Green toner particles, a green toner, and a green developer are produced in the same manner as in Example 1 except that the time periods of the sample mill treatment when the green toner particles and the external additive are mixed are changed to 30 seconds for the first time and 20 seconds for the second time.

### Example 12

Green toner particles, a green toner, and a green developer are produced in the same manner as in Example 1 except that the polymethyl methacrylate resin particles are not externally added.

### Example 13

Green toner particles, a green toner, and a green developer are produced in the same manner as in Example 1 except that the strontium titanate particles are not externally added.

### Examples 14 to 17 and Comparative Examples 2 to 5

Green toner particles, a green toner, and a green developer are produced in the same manner as in Example 1 except that the amount of the pigment dispersion liquid used in the production of the green toner particles is changed.

### Examples 18 to 19

Green toner particles, a green toner, and a green developer are produced in the same manner as in Example 1 except that the particle size of the fluorescent pigment and/or the particle size of the non-fluorescent pigment is changed to the specifications described in Table 1. The particle size of the pigment is controlled by the processing time of the continuous key mill in the preparation of the pigment dispersion liquid.

### <Performance Evaluation>

### [Image Formation]

Iridesse Production Press (FUJIFILM Business Innovation Corp.) is prepared, the developer is placed in a developing device, and the toner is placed in a toner cartridge.

In an environment at a temperature of 25° C. and a relative humidity of 55%, a solid image (density 100%, size 5 cm×5 cm, toner applied amount 4.0 g/m²) of green single color is formed on 4A size coated paper (OS coated paper, 127 g/m², FUJIFILM Business Innovation Corp.).

### [Reflectance]

Image formation is performed on 100 sheets, and the spectral reflectances (measurement wavelength range 400 nm to 700 nm) are measured at 10 places in the solid image on the 100th sheet with the use of a reflection spectrodensitometer X-Rite939 (aperture size 4 mm, X-Rite, Inc.). The average value of the reflectance of the reflection peaks is calculated and classified as follows.
A: The reflectance at the reflection peak is 80% or more
B: The reflectance at the reflection peak is 70% or more and less than 80%
C: The reflectance at the reflection peak is less than 70%

### [Color Streak]

After image formation of 100,000 sheets, the last 10 images are visually observed, and the photoreceptor contact part of the photoreceptor cleaning blade is observed with a microscope (VH6200, KEYENCE CORPORATION) at a magnification of 100 times. The number of color streaks generated in the image and the state of the photosensitive member cleaning blade are classified as follows.
A: The number of color streaks is 0, and the photosensitive member cleaning blade is not chipped.
B: The number of color streaks is 0, and the photoreceptor cleaning blade is chipped.
C: The number of color streaks is 1 to 5, and the photoreceptor cleaning blade is chipped.
D: The number of color streaks is 6 or more, and the photoreceptor cleaning blade is chipped.

The symbols in Table 1 mean the following compounds.
PY101: C. I. Pigment Yellow 101 (Radiant Color, Radglo VSF—O-01, emission peak 520 nm), one type of the azomethine fluorescent pigment (Y)
   PG36: C. I. Pigment Green 36 (Toyocolor Co., Ltd., LIONOL GREEN 8624, reflection peak 510 nm), one type of the pigment (G)
   PG59: C. I. Pigment Green 59 (DIC Corporation, FASTOGEN GREEN C100, reflection peak 520 nm), one type of the pigment (G)
ZnSt: Zinc stearate
BN: Boron nitride
PMMA: Polymethyl methacrylate resin
SrTiO₃: Strontium titanate

TABLE 1

| | Green toner particle | | | | | | | | External additive | | |
|---|---|---|---|---|---|---|---|---|---|---|---|
| | | | | | | | | | Lubricant particle | | |
| | Fluorescent pigment | | | Non-fluorescent pigment | | | | | | | Weak |
| | | | Content | | | Content | Fluorescent pigment/ | | | Addition | adhesion |
| | | | M1 | | | M2 | Non-fluorescent pigment | | | amount | proportion |
| | Type | D1 | % by | Type | D2 | % by | D1/D2 | M1/M2 | Type | Parts by | % by |
| | — | nm | mass | — | nm | mass | — | — | — | mass | mass |
| Comparative | PY101 | 300 | 7.0 | PG36 | 150 | 3.0 | 2.0 | 2.3 | — | 0 | — |
| Example 1 | | | | | | | | | | | |
| Example 1 | PY101 | 300 | 7.0 | PG36 | 150 | 3.0 | 2.0 | 2.3 | ZnSt | 0.1 | 15 |
| Example 2 | PY101 | 300 | 7.0 | PG59 | 165 | 3.0 | 1.8 | 2.3 | ZnSt | 0.1 | 18 |
| Example 3 | PY101 | 300 | 7.0 | PG36 | 150 | 3.0 | 2.0 | 2.3 | BN | 0.1 | 22 |
| Example 4 | PY101 | 300 | 7.0 | PG36 | 150 | 3.0 | 2.0 | 2.3 | ZnSt | 0.01 | 18 |
| Example 5 | PY101 | 300 | 7.0 | PG36 | 150 | 3.0 | 2.0 | 2.3 | ZnSt | 0.02 | 16 |
| Example 6 | PY101 | 300 | 7.0 | PG36 | 150 | 3.0 | 2.0 | 2.3 | ZnSt | 4.8 | 18 |
| Example 7 | PY101 | 300 | 7.0 | PG36 | 150 | 3.0 | 2.0 | 2.3 | ZnSt | 5.2 | 18 |
| Example 8 | PY101 | 300 | 7.0 | PG36 | 150 | 3.0 | 2.0 | 2.3 | ZnSt | 0.1 | 5 |
| Example 9 | PY101 | 300 | 7.0 | PG36 | 150 | 3.0 | 2.0 | 2.3 | ZnSt | 0.1 | 7 |
| Example 10 | PY101 | 300 | 7.0 | PG36 | 150 | 3.0 | 2.0 | 2.3 | ZnSt | 0.1 | 28 |
| Example 11 | PY101 | 300 | 7.0 | PG36 | 150 | 3.0 | 2.0 | 2.3 | ZnSt | 0.1 | 35 |
| Example 12 | PY101 | 300 | 7.0 | PG36 | 150 | 3.0 | 2.0 | 2.3 | ZnSt | 0.1 | 19 |
| Example 13 | PY101 | 300 | 7.0 | PG36 | 150 | 3.0 | 2.0 | 2.3 | ZnSt | 0.1 | 16 |
| Comparative | PY101 | 300 | 2.8 | PG36 | 150 | 2.2 | 2.0 | 1.3 | ZnSt | 0.1 | 16 |
| Example 2 | | | | | | | | | | | |
| Example 14 | PY101 | 300 | 3.2 | PG36 | 150 | 2.5 | 2.0 | 1.3 | ZnSt | 0.1 | 17 |
| Comparative | PY101 | 300 | 5.0 | PG36 | 150 | 5.4 | 2.0 | 0.9 | ZnSt | 0.1 | 16 |
| Example 3 | | | | | | | | | | | |
| Example 15 | PY101 | 300 | 5.0 | PG36 | 150 | 4.8 | 2.0 | 1.0 | ZnSt | 0.1 | 18 |
| Example 16 | PY101 | 300 | 5.0 | PG36 | 150 | 1.0 | 2.0 | 5.0 | ZnSt | 0.1 | 15 |
| Comparative | PY101 | 300 | 5.0 | PG36 | 150 | 0.9 | 2.0 | 5.6 | ZnSt | 0.1 | 14 |
| Example 4 | | | | | | | | | | | |
| Example 17 | PY101 | 300 | 9.5 | PG36 | 150 | 3.0 | 2.0 | 3.2 | ZnSt | 0.1 | 16 |
| Comparative | PY101 | 300 | 10.5 | PG36 | 150 | 3.0 | 2.0 | 3.5 | ZnSt | 0.1 | 16 |
| Example 5 | | | | | | | | | | | |
| Example 18 | PY101 | 680 | 7.0 | PG36 | 150 | 3.0 | 4.5 | 2.3 | ZnSt | 0.1 | 18 |
| Example 19 | PY101 | 35 | 7.0 | PG36 | 24 | 3.0 | 1.5 | 2.3 | ZnSt | 0.1 | 19 |

| | External additive | | | | | |
|---|---|---|---|---|---|---|
| | | | Titanic acid | | | |
| | Resin particle | | compound particle | | | |
| | | Addition | | Addition | Green toner | |
| | | amount | | amount | | Color |
| | Type | Parts by | Type | Parts by | Reflectance | streak |
| | — | mass | — | mass | — | — |
| Comparative | PMMA | 0.2 | SrTiO₃ | 0.2 | B | D |
| Example 1 | | | | | | |
| Example 1 | PMMA | 0.2 | SrTiO₃ | 0.2 | A | A |
| Example 2 | PMMA | 0.2 | SrTiO₃ | 0.2 | A | A |
| Example 3 | PMMA | 0.2 | SrTiO₃ | 0.2 | B | C |
| Example 4 | PMMA | 0.2 | SrTiO₃ | 0.2 | B | C |
| Example 5 | PMMA | 0.2 | SrTiO₃ | 0.2 | B | B |
| Example 6 | PMMA | 0.2 | SrTiO₃ | 0.2 | B | B |
| Example 7 | PMMA | 0.2 | SrTiO₃ | 0.2 | B | C |
| Example 8 | PMMA | 0.2 | SrTiO₃ | 0.2 | B | C |
| Example 9 | PMMA | 0.2 | SrTiO₃ | 0.2 | A | B |
| Example 10 | PMMA | 0.2 | SrTiO₃ | 0.2 | A | B |
| Example 11 | PMMA | 0.2 | SrTiO₃ | 0.2 | B | C |
| Example 12 | — | 0 | SrTiO₃ | 0.2 | B | C |
| Example 13 | PMMA | 0.2 | — | 0 | B | C |
| Comparative | PMMA | 0.2 | SrTiO₃ | 0.2 | C | B |
| Example 2 | | | | | | |
| Example 14 | PMMA | 0.2 | SrTiO₃ | 0.2 | B | A |
| Comparative | PMMA | 0.2 | SrTiO₃ | 0.2 | C | A |
| Example 3 | | | | | | |
| Example 15 | PMMA | 0.2 | SrTiO₃ | 0.2 | B | A |
| Example 16 | PMMA | 0.2 | SrTiO₃ | 0.2 | B | A |
| Comparative | PMMA | 0.2 | SrTiO₃ | 0.2 | C | A |
| Example 4 | | | | | | |
| Example 17 | PMMA | 0.2 | SrTiO₃ | 0.2 | B | A |
| Comparative | PMMA | 0.2 | SrTiO₃ | 0.2 | C | B |
| Example 5 | | | | | | |
| Example 18 | PMMA | 0.2 | SrTiO₃ | 0.2 | B | C |
| Example 19 | PMMA | 0.2 | SrTiO₃ | 0.2 | B | C |

<Image Formation with Actual Machine>

A six-tandem-type image forming apparatus of an electrophotographic type and an intermediate transfer type is prepared. Six developing devices are filled with a pink developer, a yellow developer, a magenta developer, a cyan developer, a black developer, and a green developer (the developer of Example 1), respectively. Then, an image is formed on coated paper of A4 size based on an image data of a color-separated RGB data into the six colors. An image with good color reproducibility close to the original RGB data is obtained.

The green toner for electrostatic charge image development, the electrostatic charge image developer, the toner cartridge, the process cartridge, the image forming apparatus, and the image forming method of the present disclosure include the following aspects.

(((1)))

A green toner for electrostatic charge image development, the green toner comprising: green toner particles; and
a lubricant externally added to the green toner particles,
the green toner particles containing:
a binder resin;
an azomethine fluorescent pigment having an emission peak in a region of wavelengths of 500 nm or more and 550 nm or less of an emission spectrum; and
a non-fluorescent pigment having a reflection peak in a region of wavelengths of 480 nm or more and 540 nm or less of a reflection spectrum,
wherein
a mass proportion of the azomethine fluorescent pigment in the green toner particles is 3% by mass or more and 10% by mass or less, and
a mass-based ratio M1/M2 of a content M1 of the azomethine fluorescent pigment to a content M2 of the non-fluorescent pigment is 1 or more and 5 or less.
   (((2)))

The green toner for electrostatic charge image development according to (((1))), wherein the lubricant is contained in an amount of 0.02 parts by mass or more and 5.0 parts by mass or less with respect to 100 parts by mass of the green toner particles.

(((3)))

The green toner for electrostatic charge image development according to (((1))) or (((2))), wherein the lubricant contains fatty acid metal salt particles.

(((4)))

The green toner for electrostatic charge image development according to (((3))), wherein, when the green toner for electrostatic charge image development is dispersed in water containing a surfactant and subjected to an ultrasonic treatment at a power of 20 W and a frequency of 20 kHz for 1 minute, the fatty acid metal salt particles detached from the green toner particles are 10% by mass or more and 30% by mass or less of the fatty acid metal salt particles externally added to the green toner particles.

(((5)))

The green toner for electrostatic charge image development according to any one of (((1))) to (((4))), the green toner further comprising resin particles externally added to the green toner particles.

(((6)))

The green toner for electrostatic charge image development according to any one of (((1))) to (((5))), the green toner further comprising titanic acid compound particles externally added to the green toner particles.

(((7)))

The green toner for electrostatic charge image development according to any one of (((1))) to (((4))), the green toner further comprising resin particles and titanic acid compound particles externally added to the green toner particles.

(((8)))

The green toner for electrostatic charge image development according to any one of (((1))) to (((7))), wherein
the azomethine fluorescent pigment has a volume-average particle size D1 of 30 nm or more and 800 nm or less, and
the volume-average particle size D1 of the azomethine fluorescent pigment and a volume-average particle size D2 of the non-fluorescent pigment satisfy a relationship D1>D2.
   (((9)))

The green toner for electrostatic charge image development according to any one of (((1))) to (((8))), wherein the azomethine fluorescent pigment is C. I. Pigment Yellow 101.

(((10)))

The green toner for electrostatic charge image development according to any one of (((1))) to (((9))), wherein the non-fluorescent pigment is at least one selected from the group consisting of C. I. Pigment Green 36, C. I. Pigment Green 7, C. I. Pigment Green 58, C. I. Pigment Green 59, and C. I. Pigment Blue 76.

(((11)))

An electrostatic charge image developer comprising the green toner for electrostatic charge image development according to any one of (((1))) to (((10))).

(((12)))

A toner cartridge containing the green toner for electrostatic charge image development according to any one of (((1))) to (((10))), the toner cartridge being detachably attached to an image forming apparatus.

(((13)))

A process cartridge containing the electrostatic charge image developer according to (((11))), the process cartridge comprising a developing unit that develops, as a toner image, an electrostatic charge image formed on a surface of an imaging holding member by using the electrostatic charge image developer, the process cartridge being detachably attached to an image forming apparatus.

(((14)))

An image forming apparatus comprising:
an image holding member;
a charging unit that charges a surface of the image holding member;
an electrostatic charge image forming unit that forms an electrostatic charge image on the surface of the image holding member that has been charged;
a developing unit that contains the electrostatic charge image developer according to (((11))) and develops, as a toner image, the electrostatic charge image formed on the surface of the image holding member by using the electrostatic charge image developer;
a transfer unit that transfers the toner image formed on the surface of the image holding member onto a surface of a recording medium; and
a fixing unit that fixes the toner image transferred onto the surface of the recording medium.
   (((15)))

An image forming method comprising:
charging a surface of an image holder;
forming an electrostatic charge image on the surface of the image holder that has been charged;
developing, as a toner image, the electrostatic charge image formed on the surface of the image holder by using the electrostatic charge image developer according to (((11)));
transferring the toner image formed on the surface of the image holder onto a surface of a recording medium; and
fixing the toner image transferred onto the surface of the recording medium.
   (((16)))

An image forming apparatus comprising first to sixth image forming units of an electrophotographic type that form images of colors of pink, yellow, magenta, cyan, black, and green, respectively,
wherein the image forming unit that forms a green image contains the electrostatic charge image developer according to (((11))).
   (((17)))

An image forming method comprising forming first to sixth images of an electrophotographic type in which images of colors of pink, yellow, magenta, cyan, black, and green are respectively formed,
wherein the electrostatic charge image developer according to (((11))) is used in forming the image of green.

What is claimed is:

1. A green toner for electrostatic charge image development, the green toner comprising:
green toner particles; and
a lubricant externally added to the green toner particles,
the green toner particles containing:
a binder resin;
an azomethine fluorescent pigment having an emission peak in a region of wavelengths of 500 nm or more and 550 nm or less of an emission spectrum; and
a non-fluorescent pigment having a reflection peak in a region of wavelengths of 480 nm or more and 540 nm or less of a reflection spectrum,
wherein
a mass proportion of the azomethine fluorescent pigment in the green toner particles is 3% by mass or more and 10% by mass or less, and
a mass-based ratio M1/M2 of a content M1 of the azomethine fluorescent pigment to a content M2 of the non-fluorescent pigment is 1 or more and 5 or less.

2. The green toner for electrostatic charge image development according to claim 1, wherein the lubricant is contained in an amount of 0.02 parts by mass or more and 5.0 parts by mass or less with respect to 100 parts by mass of the green toner particles.

3. The green toner for electrostatic charge image development according to claim 1, wherein the lubricant contains fatty acid metal salt particles.

4. The green toner for electrostatic charge image development according to claim 3, wherein, when the green toner for electrostatic charge image development is dispersed in water containing a surfactant and subjected to an ultrasonic treatment at a power of 20 W and a frequency of 20 kHz for 1 minute, the fatty acid metal salt particles detached from the green toner particles are 10% by mass or more and 30% by mass or less of the fatty acid metal salt particles externally added to the green toner particles.

5. The green toner for electrostatic charge image development according to claim 1, the green toner further comprising resin particles externally added to the green toner particles.

6. The green toner for electrostatic charge image development according to claim 1, the green toner further comprising titanic acid compound particles externally added to the green toner particles.

7. The green toner for electrostatic charge image development according to claim 1, the green toner further comprising resin particles and titanic acid compound particles externally added to the green toner particles.

8. The green toner for electrostatic charge image development according to claim 1, wherein
the azomethine fluorescent pigment has a volume-average particle size D1 of 30 nm or more and 800 nm or less, and
the volume-average particle size D1 of the azomethine fluorescent pigment and a volume-average particle size D2 of the non-fluorescent pigment satisfy a relationship D1>D2.

9. The green toner for electrostatic charge image development according to claim 1, wherein the azomethine fluorescent pigment is C. I. Pigment Yellow 101.

10. The green toner for electrostatic charge image development according to claim 1, wherein the non-fluorescent pigment is at least one selected from the group consisting of C. I. Pigment Green 36, C. I. Pigment Green 7, C. I. Pigment Green 58, C. I. Pigment Green 59, and C. I. Pigment Blue 76.

11. An electrostatic charge image developer comprising the green toner for electrostatic charge image development according to claim 1.

12. An electrostatic charge image developer comprising the green toner for electrostatic charge image development according to claim 2.

13. An electrostatic charge image developer comprising the green toner for electrostatic charge image development according to claim 3.

14. An electrostatic charge image developer comprising the green toner for electrostatic charge image development according to claim 4.

15. A toner cartridge containing the green toner for electrostatic charge image development according to claim 1, the toner cartridge being detachably attached to an image forming apparatus.

16. A process cartridge containing the electrostatic charge image developer according to claim 11, the process cartridge comprising a developing unit that develops, as a toner image, an electrostatic charge image formed on a surface of an imaging holding member by using the electrostatic charge image developer, the process cartridge being detachably attached to an image forming apparatus.

17. An image forming apparatus comprising:
an image holding member;
a charging unit that charges a surface of the image holding member;
an electrostatic charge image forming unit that forms an electrostatic charge image on the surface of the image holding member that has been charged;
a developing unit that contains the electrostatic charge image developer according to claim 11 and develops, as a toner image, the electrostatic charge image formed on the surface of the image holding member by using the electrostatic charge image developer;
a transfer unit that transfers the toner image formed on the surface of the image holding member onto a surface of a recording medium; and
a fixing unit that fixes the toner image transferred onto the surface of the recording medium.

18. An image forming method comprising:
charging a surface of an image holder;
forming an electrostatic charge image on the surface of the image holder that has been charged;
developing, as a toner image, the electrostatic charge image formed on the surface of the image holder by using the electrostatic charge image developer according to claim 11;
transferring the toner image formed on the surface of the image holder onto a surface of a recording medium; and
fixing the toner image transferred onto the surface of the recording medium.

19. An image forming apparatus comprising first to sixth image forming units of an electrophotographic type that form images of colors of pink, yellow, magenta, cyan, black, and green, respectively,
wherein the image forming unit that forms a green image contains the electrostatic charge image developer according to claim 11.

20. An image forming method comprising forming first to sixth images of an electrophotographic type in which images of colors of pink, yellow, magenta, cyan, black, and green are respectively formed,
wherein the electrostatic charge image developer according to claim 11 is used in forming the image of green.
